(19) United States
(12) Patent Application Publication
(10) Pub. No.: US 2025/0304166 A1
(43) Pub. Date: Oct. 2, 2025

(54) VEHICLE CONTROL DEVICE, FLYING VEHICLE CONTROL DEVICE, VEHICLE CONTROL METHOD AND STORAGE MEDIUM

(71) Applicant: HONDA MOTOR CO., LTD., Tokyo (JP)

(72) Inventor: Toru OTAGAKI, Saitama (JP)

(21) Appl. No.: 19/063,332

(22) Filed: Feb. 26, 2025

(30) Foreign Application Priority Data
Mar. 29, 2024 (JP) 2024-057660

(51) Int. Cl. B62D 15/02; G06V 20/56

(52) U.S. Cl. CPC B62D 15/0265; G06V 20/56

(57) ABSTRACT

A vehicle control device includes: an input image acquirer that acquires an input image; a target steering amount calculator that calculates a target steering amount based on the input image; and a steering controller that manipulates an electric power steering to a positive side or a negative side based on the target steering amount. The target steering amount calculator is configured to execute: processing of recognizing a positive-side dividing line LP and a negative-side dividing line LN of the vehicle; processing of calculating at least either one of a positive-side area value between a neutral reference line L0 determined virtually and the positive-side dividing line LP, and a negative-side area value between the neutral reference line L0 and the negative-side dividing line LN; and processing of calculating the target steering amount based on at least either one of the positive-side area value and the negative-side area value.

This application is based on and claims the benefit of priority from Japanese Patent Application No. 2024-057660, filed on 29 Mar. 2024, the content of which is incorporated herein by reference.

### BACKGROUND OF THE INVENTION

### Field of the Invention

The present invention relates to a vehicle control device, a flying vehicle control device, a vehicle control method and a storage medium. In more detail, it relates to a vehicle control device, a flying vehicle control device, a vehicle control method and a storage medium for controlling a vehicle or flying vehicle based on images captured by a camera.

### Related Art

In recent years, efforts are becoming more active to provide access to a sustainable transportation system made taking account of the most vulnerable people among traffic participants. Directed to this realization, research and development for further improving the safety and convenience of traffic has been given focus, through research and development relating to driving aid technology.

For example, Japanese Unexamined Patent Application, Publication No. 2023-82451 discloses preventive safety technologies that generate a target trajectory indicating a route on which an own vehicle is to travel in the future, based on images representing the peripheral situation of an own vehicle obtained by an onboard camera, and further automatically manipulates the steering and accelerator of the vehicle based on this target trajectory.
Patent Document 1: Japanese Unexamined Patent Application, Publication No. 2023-82451

### SUMMARY OF THE INVENTION

Herein, the technology disclosed in Japanese Unexamined Patent Application, Publication No. 2023-82451 converts an image obtained by an onboard camera into bird's eye view coordinate system, upon calculating control amounts such as for the steering and accelerator from an image obtained by an onboard camera, and further calculates the target trajectory in this bird's eye view coordinate system. However, in the control based on such a bird's eye view, there is a tendency for the number of parameters required in tuning, and the load on the onboard computer increasing. In addition, in the control based on such a bird's eye view, the workload for alignment work of the output data upon integrating the output data of a plurality of sensors also increases.

The present invention has an object of providing a vehicle control device, flying vehicle control device, vehicle control method and storage medium which can control a vehicle or flying vehicle with less burden based on images obtained by a camera, and thus has an object of contributing to the development of a sustainable transportation system.

A vehicle control device according to a first aspect of the present invention (for example, the vehicle control device 1 described later) includes: an input image acquirer (for example, the input image acquirer 2 described later) that acquires an image captured by a camera (for example, the onboard camera C described later) directed to a front side viewing from a vehicle (for example, the vehicle V described later), as an input image; a target steering amount calculator (for example, the target steering amount calculator 3 described later) that calculates a target steering amount (for example, the target steering amount Str described later) for a steering mechanism (for example, the electric power steering device 9 described later) of the vehicle based on the input image; and a steering controller (for example, the steering controller 4 described later) that manipulates the steering mechanism to a positive side or a negative side based on the target steering amount, in which the target steering amount calculator is configured to execute: processing of recognizing a travel path of the vehicle based on the input image; processing of calculating at least either one of a positive-side area value (for example, the positive-side area value Sp described later) between a neutral reference line (for example, the neutral reference line L0 described later) determined virtually in the input image and a positive-side dividing line (for example, the positive-side dividing line LP described later) which is a boundary on a positive side of the travel path, and a negative-side area value (for example, the negative-side area value Sn described later) between the neutral reference line and a negative-side dividing line (for example, the negative-side dividing line LN described later) which is a boundary on a negative side of the travel path; and processing of calculating the target steering amount based on at least either one of the positive-side area value and the negative-side area value.

According to a second aspect of the present invention, in this case, it is preferable for the target steering amount calculator to calculate the target steering amount so as to become larger to a positive side as the positive-side area value becomes larger, and to calculate the target steering amount so as to become larger to a negative side as the negative-side area value becomes larger.

According to a third aspect of the present invention, in this case, it is preferable for the target steering amount calculator to virtually set, in the input image, the neutral reference line extending in an up-down direction of the input image, and a plurality of horizontal reference lines (for example, the horizontal reference lines LT1 to LT6 described later) that intersect with the neutral reference line, to calculate a value of an area of a region surrounded by the positive-side dividing line, the neutral reference line and the horizontal reference lines as the positive-side area value, and to calculate a value of an area of a region surrounded by the negative-side dividing line, the neutral reference line and the horizontal reference lines as the negative-side area value.

According to a fourth aspect of the present invention, in this case, it is preferable for the target steering amount calculator to calculate the target steering amount by subtracting a predetermined negative-side reference value from the positive-side area value, subtracting the negative-side area value from a predetermined positive-side reference value, or subtracting the negative-side area value from the positive-side area value.

According to a fifth aspect of the present invention, in this case, it is preferable for the target steering amount calculator, in a case of the positive-side dividing line and the neutral reference line intersecting in the input image, to calculate the positive-side area value by subtracting a value of an area between a portion of the neutral reference line on an upper side from the intersection point with the positive-side dividing line and the positive-side dividing line, from a value of an area between a portion of the neutral reference line on a lower side from the intersection point and the positive-side dividing line.

According to a sixth aspect of the present invention, in this case, it is preferable for the target steering amount calculator, in a case of the negative-side dividing line and the neutral reference line intersecting in the input image, to calculate the negative-side area value by subtracting a value of an area between a portion of the neutral reference line on an upper side from an intersection point with the negative-side dividing line and the negative-side dividing line, from a value of an area between a portion of the neutral reference line on a lower side from the intersection point with the negative-side dividing line and the negative-side dividing line.

According to a seventh aspect of the present invention, in this case, it is preferable for the target steering amount calculator to calculate the target steering amount by dividing a difference between the positive-side area value and the negative-side reference line by a sum of the positive-side area value and the negative-side reference line, dividing a difference between the positive-side reference line and the negative-side area value by a sum of the positive-side reference line and the negative-side area value, or dividing a difference between the positive-side area value and the negative-side area value by a sum of the positive-side area value and the negative-side area value.

According to an eighth aspect of the present invention, in this case, it is preferable for the camera to be provided at a center in a width direction of a body of the vehicle, and the target steering amount calculator, in a case of causing the vehicle to travel along within an own vehicle travel lane between the positive-side dividing line and the negative-side dividing line, to be configured to execute processing of setting the neutral reference line at a center in a width direction of the input image.

According to a ninth aspect of the present invention, in this case, it is preferable for the target steering amount calculator to be configured to execute: processing of storing, as a center position, a position of the neutral reference line at which the positive-side area value and the negative-side area value are made equal when the vehicle is traveling at a center in a width direction of a straight road, and processing of setting the neutral reference line at the center position, in a case of causing the vehicle to travel along within an own vehicle travel lane between the positive-side dividing line and the negative-side dividing line.

According to a tenth aspect of the present invention, in this case, it is preferable for the target steering amount calculator to be configured to execute: processing to cause the neutral reference line to move at a predetermined speed to a positive side in the input image, in a case of causing the vehicle to travel from the own vehicle travel lane toward a positive-side adjacent travel lane which is adjacent to the positive-side dividing line; and processing of causing the neutral reference line to move at a predetermined speed to a negative side in the input image, in a case of causing the vehicle to travel from the own vehicle travel lane toward a negative-side adjacent travel lane which is adjacent to the negative-side dividing line.

According to an eleventh aspect of the present invention, in this case, it is preferable for the target steering amount calculator to be configured to execute: processing of causing the neutral reference line to move to a negative side in the input image, in a case of recognizing the positive-side dividing line and a positive-side obstacle (for example, the positive-side obstacle OBp described later) hiding a part of the positive-side dividing line, based on the input image; and processing of causing the neutral reference line to move to a positive side in the input image, in a case of recognizing the negative-side dividing line and a negative-side obstacle hiding a part of the negative-side dividing line, based on the input image.

According to a twelfth aspect of the present invention, in this case, it is preferable for the target steering amount calculator to be configured to execute: processing of estimating the negative-side dividing line based on the positive-side dividing line, in a case of being able to recognize the positive-side dividing line and not being able to recognize the negative-side dividing line based on the input image; and processing of estimating the positive-side dividing line based on the negative-side dividing line, in a case of being able to recognize the negative-side dividing line and not being able to recognize the positive-side dividing line based on the input image.

According to a thirteenth aspect of the present invention, in this case, it is preferable for the target steering amount calculator to be configured to execute: processing of interpolating, in a case of recognizing the positive-side dividing line and a positive-side obstacle (for example, the positive-side obstacle OBp described later) hiding a part of the positive-side dividing line based on the input image, a portion of the positive-side dividing line being hidden by the positive-side obstacle by a line along a lateral face on a negative side of the positive-side obstacle; and processing of interpolating, in a case of recognizing the negative-side dividing line and a negative-side obstacle hiding a part of the negative-side dividing line based on the input image, a portion of the negative-side dividing line being hidden by the negative-side obstacle by a line along a lateral face on a positive side of the negative-side obstacle.

According to a fourteenth aspect of the present invention, in this case, it is preferable to further include: a target vehicle speed calculator (for example, the target vehicle speed calculator 5 described later) that calculates a target vehicle speed of the vehicle based on the input image; and an acceleration-deceleration controller (for example, the acceleration-deceleration controller 6 described later) that manipulates an acceleration-deceleration device (for example, the braking device 7 and power plant 8 described later) of the vehicle based on the target vehicle speed, in which the target vehicle speed calculator is configured to execute: processing of recognizing the travel path based on the input image; processing of setting a speed control reference line (for example, the speed control reference line LT3 described later) extending in a width direction relative to the input image; processing of calculating a value of an area of the travel path on an upper side from the speed control reference line as an upper area value (for example, the upper area value St described later); processing of calculating a value of an area of the travel path on a lower side from the speed control reference line as a lower area value (for example, the lower are value Sb described later); processing of calculating a sum of the upper area value and the lower area value as a total area value (for example, the total area value Stotal described later); processing of calculating a value of a ratio of the upper area value relative to the total area value as an upper-lower ratio value (for example, the upper-lower ratio value r described later); and processing of calculating the target vehicle speed based on the upper-lower ratio value.

According to a fifteenth aspect of the present invention, in this case, it is preferable for the target vehicle speed calculator to calculate the target vehicle speed so as to become smaller as the upper-lower ratio value becomes larger.

According to a sixteenth aspect of the present invention, in this case, it is preferable for the vehicle control device to further include: a storage medium that stores a plurality of speed tables associating the upper-lower ratio value and the target vehicle speed, in which the target vehicle speed calculator is configured to execute: processing of estimating a curvature parameter (for example, the curvature parameter Gall described later) of the travel path based on the input image; and processing of selecting one among the plurality of the speed tables based on the curvature parameter, and calculating the target vehicle speed based on the speed table selected and the upper-lower ratio value.

According to a seventeenth aspect of the present invention, in this case, it is preferable for the vehicle control device to further include: a storage medium that stores a plurality of speed tables associating the upper-lower ratio value and the target vehicle speed, in which the target vehicle speed calculator is configured to execute: processing of acquiring a travel mode of the vehicle; and processing of selecting one among a plurality of the speed tables based on the travel mode, and calculating the target vehicle speed based on the speed table selected and the upper-lower ratio value.

According to an eighteenth aspect of the present invention, in this case, it is preferable for the target vehicle speed calculator to be configured to execute: processing of estimating the negative-side dividing line based on the positive-side dividing line, in a case of being able to recognize the positive-side dividing line and not being able to recognize the negative-side dividing line based on the input image; and processing of estimating the positive-side dividing line based on the negative-side dividing line, in a case of being able to recognize the negative-side dividing line and not being able to recognize the positive-side dividing line based on the input image.

A flying vehicle control device according to a nineteenth aspect of the present invention (for example, the flying vehicle control device 1A described later) includes: an input image acquirer (for example, the input image acquirer 2A described later) that acquires an image captured by a camera (for example the camera CA described later) directed to a front side viewing from the flying vehicle (for example, the flying vehicle F described later) as an input image; a first target control amount calculator (for example, the yaw axis target control amount calculator 31 described later) that calculates a first target control amount (for example, the yaw axis target control amount uy described later) for a first axis attitude control mechanism (for example, the yaw axis attitude control mechanism 9Y) that causes an attitude around a first axis (for example, the yaw axis Oy described later) of the flying vehicle to change based on the input image; and a first axis attitude controller (for example, the yaw axis attitude controller 41 described later) that manipulates the first axis attitude control mechanism to a positive side or a negative side based on the first target control amount, in which the first target control amount calculator is configured to execute: processing of recognizing a tracking target (for example, the tracking target T described later) of the flying vehicle based on the input image; processing of setting a flight path virtually on the input image based on a position of the tracking target in the input image; processing of calculating a first positive-side area value (for example, the positive-side area value Syp described later) between a first control reference line (for example, the yaw axis control reference line Ly described later) determined virtually in the input image and a first positive-side dividing line (for example, the flight dividing line LF1, LF2 described later) which is a boundary on a positive side of the flight path, and a first negative-side area value (for example, the negative-side area value Syn described later) between the first control reference line and a first negative-side dividing line (for example, the flight dividing line LF3, LF4 described later) which is a boundary on a negative side of the flight path; and processing of calculating the first target control amount based on the first positive-side area value and the first negative-side area value.

According to a twentieth aspect of the present invention, in this case, it is preferable for the flying vehicle control device to further include: a second target control amount calculator (for example, the pitch axis target control amount calculator 32 described later) that calculates a second target control amount (for example, the pitch axis target control amount up described later) for a second axis attitude control mechanism (for example, the pitch axis attitude control mechanism 9P described later) that causes an attitude around a second axis (for example, the pitch axis Op described later) of the flying vehicle to change based on the input image; and a second axis attitude controller (for example, the pitch axis attitude controller 42 described later) that manipulates the second axis attitude control mechanism to a positive side or a negative side based on the second target control amount, in which the second target control amount calculator is configured to execute: processing of calculating a second positive-side area value (for example, the positive-side area value Spp described later) between a second control reference line (for example, the pitch axis control reference line Lp described later) determined virtually in the input image so as to be orthogonal to the first control reference line, and a second positive-side dividing line (for example, the flight dividing line LF2, LF3 described later) which is a boundary on a positive side of the flight path, and a second negative-side area value (for example, the negative-side are value Spn described later) between the second control reference line and a second negative-side dividing line (for example, the flight dividing line LF1, LF4 described later) which is a boundary on a negative side of the flight path; and processing of calculating the second target control amount based on the second positive-side area value and the second negative-side area value.

According to a twenty-first aspect of the present invention, in this case, it is preferable for the flying vehicle control device to further include: a third target control amount calculator (for example, the roll axis target control amount calculator 33 described later) that calculates a third target control amount (for example, the roll axis target control amount ur described later) for a third axis attitude control mechanism (for example, the roll axis attitude control mechanism 9R described later) that causes an attitude around a third axis (for example, the roll axis Or described later) of the flying vehicle to change based on the input image; and a third axis attitude controller (for example, the roll axis attitude controller 43 described later) that manipulates the third axis attitude control mechanism to a positive side or a negative side based on the third target control amount, in which the third target control amount calculator is configured to execute: processing of setting a target attitude line (for example, the target attitude line Lt described later) virtually on the input image based on an attitude of the tracking target in the input image; processing of calculating a third area value (for example, the positive-side area value Srp and negative-side area value Srn described later) between a third control reference line (for example, the first roll axis control reference line Lr1 described later) determined virtually in the input image and the target attitude line; and processing of calculating the third target control amount based on the third area value.
(1) In the present invention, the input image acquirer acquires, as the input image, an image captured by a camera directed to the front side viewing from the vehicle, the target steering amount calculator calculates the target steering amount for the steering mechanism of the vehicle based on the input image, and the steering controller manipulates the steering mechanism to the positive side or the negative side based on the target steering amount. In addition, the target steering amount calculator of the present invention recognizes the travel path of the vehicle based on the input image, and calculates at least either one of the positive-side area value between the neutral reference line and the positive-side dividing line of the own vehicle travel path in the input image, and the negative-side area value between the neutral reference line and the negative-side dividing line of the travel path. Herein, there is a tendency for the positive-side area value to become larger proportionally to the distance along the width direction between the neutral dividing line and the positive-side dividing line, and the negative-side area value to become larger proportionally to the distance along the width direction between the neutral dividing line and the negative-side dividing line. In other words, in the case of trying to move the vehicle along the travel path, it is necessary to manipulate steering mechanism to the positive side or the negative side so that the distance between the neutral dividing line and the positive-side dividing line or negative-side dividing line, i.e. the positive-side area value or the negative-side area value, becomes roughly constant. In addition, in the case of the travel path on the front side curving to the positive side when viewing from the vehicle, i.e. case of requiring to manipulate the steering mechanism gradually to the positive side, since the distance along the width direction between the neutral dividing line and the positive-side dividing line becomes longer as distancing from the vehicle, the positive-side area value increases. In addition, in the case of the travel path on the front side curving to the negative side when viewing from the vehicle, i.e. case of requiring to manipulate the steering mechanism gradually to the negative side, since the distance along the width direction between the neutral dividing line and the negative-side dividing line becomes longer as distancing from the vehicle, the negative-side area value increases. In this way, the steering amount in the case of having the vehicle travel along the travel path has a correlation with the positive-side area value or negative-side area value defined in the above way. Therefore, according to the present invention, the vehicle can be made to move along the travel path by calculating the target steering amount using such a correlation between the steering amount and the area value in the input image. In this way, according to the present invention, since it is possible to calculate the proper target steering amount by simply calculating the area value from the input image, it is possible to reduce the load on the computer handling such computations.

In addition, with the input image captured by the camera equipped to the vehicle, the area of an object that is far away from the vehicle appears smaller than the area of an object that is near the vehicle. Therefore, by configuring in the above way, the positive-side area value and the negative-side area value calculated can be considered to be naturally weighted without going through the setting of parameters. Consequently, by calculating the target steering amount based on such a positive-side area value or negative-side area value, it is possible to reduce the number of parameters required by tuning and the load on the computer, compared to the conventional technology, and thus can contribute to the development of a sustainable transportation system.
(2) In the present invention, the target steering amount calculator calculates the target steering amount so as to become larger to the positive side as the positive-side area value becomes larger, and calculates the target steering amount so as to become larger to the negative side as the negative-side area value becomes larger. It is thereby possible to have the vehicle move so as not to deviate from the travel path.
(3) In the present invention, the target steering amount calculator calculates, as the positive-side area value, a value of the area of the region surrounded by the neutral reference line extending in the up-down direction in the input image, the plurality of horizontal reference lines intersecting this neutral reference line, and the positive-side dividing line, and calculates, as the negative-side area value, a value of the area of the region surrounded by the neutral reference line, the plurality of horizontal reference lines and the negative-side dividing line. Consequently, according to the present invention, it is possible to calculate the positive-side area value or negative-side area value with a simple computation.
(4) In the present invention, the target steering amount calculator calculates the target steering amount by subtracting a predetermined negative-side reference value from the positive-side area value, subtracting the negative-side area value from a predetermined positive-side reference value, or subtracting the negative-side area value from the positive-side area value. Consequently, according to the present invention, so long as it is possible to recognize at least either one of the positive-side dividing line and negative-side dividing line from the input image, the target steering amount can be calculated.
(5) In the present invention, the target steering amount calculator, in the case of the positive-side dividing line and the neutral reference line intersecting in the input image, i.e. case of the positive-side dividing line greatly curving to the negative side ahead of the vehicle, calculates the positive-side area value by subtracting the value of the area between a portion of the neutral reference line on an upper side from the intersection point (i.e. far side viewing from the vehicle) and the positive-side dividing line, from the value of the area between a portion of the neutral reference line on a lower side from the intersection point with the positive-side dividing line (near side viewing from the vehicle) and the positive-side dividing line. It is thereby possible to calculate the positive-side area value taking consideration of the curvature of the travel path.
(6) In the present invention, the target steering amount calculator, in the case of the negative-side dividing line and the neutral reference line intersecting in the input image, i.e. case of the negative-side dividing line curving greatly to the positive side ahead of the vehicle, calculates the negative-side area value by subtracting the value of the area between a portion of the neutral reference line on an upper side from the intersection point (i.e. far side viewing from the vehicle) and the negative-side dividing line, from the value of the area between a portion of the neutral reference line on a lower side from the intersection point with the negative-side dividing line (i.e. near side viewing from the vehicle) and the negative-side dividing line. It is thereby possible to calculate the negative-side area value taking consideration of the curvature of the travel path.
(7) In the present invention, the target steering amount calculator calculates the target steering amount by dividing the difference between the positive-side area value and the negative-side reference line by the sum of the positive-side area value and the negative-side reference line, dividing the difference between the positive-side reference line and the negative-side area value by the sum of the positive-side area value and the negative-side area value, or dividing the difference between the positive-side area value and the negative-side area value by the sum of the positive-side area value and the negative-side area value. In other words, in the present invention, it is possible to improve the robustness by calculating the target steering amount by normalizing the positive-side area value and the negative-side area value.
(8) In the present invention, the camera is provided at the center in the width direction of the vehicle body. In addition, the target steering amount calculator, in the case of causing the vehicle to travel along within the own vehicle travel lane between the positive-side dividing line and the negative-side dividing line, sets the neutral reference line at the center in the width direction of the input image. It is thereby possible to have the vehicle travel so that the neutral reference line is located at the center between the positive-side dividing line and the negative-side dividing line in the input image, i.e. so that the vehicle body is located at the center of the own vehicle travel lane.
(9) In the present invention, the target steering amount calculator stores, as a center position, the position of the neutral reference line at which the positive-side area value and the negative-side area value are made equal, when the vehicle is traveling at the center in the width direction of a straight road. In addition, the target steering amount calculator sets the neutral reference line at a center position, in the case of causing the vehicle to travel along within the own vehicle travel lane between the positive-side dividing line and the negative-side dividing line. It is thereby possible to cause the vehicle to travel so that the vehicle body is positioned at the center in the own vehicle travel lane, even in the case of the camera not being provided at the center in the width direction of the vehicle body.
(10) In the present invention, the target steering amount calculator, in the case of causing the vehicle to travel from the own vehicle travel lane towards a positive-side adjacent travel lane, causes the neutral reference line to move at a predetermined speed to the positive side in the input image. It is thereby possible to cause the vehicle to automatically move from the own vehicle travel lane to the positive-side adjacent travel lane. In addition, the target steering amount calculator, in the case of causing the vehicle to travel from the own vehicle travel lane towards the negative-side adjacent travel lane, causes the neutral reference line to move at a predetermined speed to the negative side in the input image. It is thereby possible to cause the vehicle to automatically move from the own vehicle travel lane to the negative-side adjacent travel lane.
(11) In the present invention, the target steering amount calculator, in the case of recognizing the positive-side dividing line and a positive-side obstacle hiding a part thereof based on the input image, causes the neutral reference line to move to the negative side in the input image. It is thereby possible to make the vehicle avoid the positive-side obstacle. In addition, the target steering amount calculator, in the case of recognizing the negative-side dividing line and a negative-side obstacle hiding a part thereof based on the input image, causes the neutral reference line to move to the positive side in the input image. It is thereby possible to make the vehicle avoid the negative-side obstacle.
(12) In the present invention, the target steering amount calculator, in the case of being able to recognize the positive-side dividing line and not being able to recognize the negative-side dividing line based on the input image, estimates the negative-side dividing line based on the positive-side dividing line. In addition, the target steering amount calculator, in the case of being able to recognize the negative-side dividing line and not being able to recognize the positive-side dividing line based on the input image, estimates the positive-side dividing line based on the negative-side dividing line. Consequently, according to the present invention, even in the case of not being able to recognize any of the positive-side dividing line and negative-side dividing line, it is possible to calculate both the positive-side area value and the negative-side area value, and consequently calculate the target steering amount using both this positive-side area value and negative-side area value.
(13) In the present invention, the target steering amount calculator, in the case of recognizing the positive-side dividing line and a positive-side obstacle hiding a part thereof based on the input image, interpolates a portion of the positive-side dividing line hidden by the positive-side obstacle, by a line along a lateral face on the negative side of the positive-side obstacle. Since it is thereby possible to make the positive-side area value smaller by the amount occupied by the positive-side obstacle, the vehicle can be made to avoid the positive-side obstacle. In addition, the target steering amount calculator, in the case of recognizing the negative-side dividing line and the negative-side obstacle hiding a part thereof based on the input image, interpolates a portion of the negative-side dividing line hidden by the negative-side obstacle by a line along a lateral face on the positive side of the negative-side obstacle. Since it is thereby possible to make the negative-side area value smaller by the amount occupied by the negative-side obstacle, the vehicle can be made to avoid the negative-side obstacle.
(14) In the present invention, the target vehicle speed calculator calculates the target vehicle speed based on the input image, and the acceleration-deceleration controller manipulates the acceleration-deceleration device based on the target vehicle speed. In addition, the target vehicle speed calculator recognizes the travel path based on the input image, sets the speed control reference line extending in the width direction of the input image, calculates the value of the area of the travel path on the upper side from the speed control reference line as an upper area value, calculates the value of the area of the travel path on a lower side from the speed control reference line as a lower area value, calculates a sum of these area values as a total area value, calculates a value of a ratio of the upper area value relative to the total area value as an upper-lower ratio value, and further calculates a target vehicle speed based on the upper-lower ratio value. Herein, in the case of the travel path on the front side of the vehicle curving to the positive side or the negative side, i.e. case requiring to decelerate the vehicle speed, the upper-lower ratio value becomes larger than a case of the travel path being straight ahead. Consequently, according to the present invention, it is possible to control the vehicle speed with a simply computation using the correlation between the appropriate vehicle speed according to the status of the travel path ahead, and the upper-lower ratio value defined as described above.
(15) In the present invention, the target vehicle speed calculator calculates the target vehicle speed so as to become smaller as the upper-lower ratio value becomes larger. It is thereby possible to change the vehicle speed according to the status of the travel path on the front side of the vehicle.
(16) In the present invention, the target vehicle speed calculator estimates a curvature parameter of the travel path based on the input image, further selects one from among the plurality of speed tables based on this curvature parameter, and calculates the target vehicle speed based on the selected speed table and the upper-lower ratio value. Consequently, according to the present invention, it is possible to change the vehicle speed according to the curvature parameter of the travel path.
(17) In the present invention, the target vehicle speed calculator acquires the travel mode of the vehicle, further selects one from among a plurality of speed tables based on this travel mode, and calculates the target vehicle speed based on the selected speed table and the upper-lower ratio value. Consequently, according to the present invention, it is possible to change the vehicle speed according to the curvature parameter of the travel path.
(18) In the present invention, the target vehicle speed calculator, in the case of being able to recognize the positive-side dividing line and not being able to recognize the negative-side dividing line based on the input image, estimates the negative-side dividing line based on the positive-side dividing line. In addition, the target vehicle speed calculator, in the case of being able to recognize the negative-side dividing line and not being able to recognize the positive-side dividing line based on the input image, estimates the positive-side dividing line based on the negative-side dividing line. Consequently, according to the present invention, even in the case of not being able to recognize any of the positive-side dividing line and the negative-side dividing line, it is possible to calculate the upper area value, lower area value, upper-lower ratio value, etc., and consequently possible to calculate the target vehicle speed using this upper area value, lower area value, upper-lower ratio value, etc.
(19) In the present invention, the input image acquirer acquires an image captured by the camera directed to the front side viewing from the flying vehicle as an input image, the first target control amount calculator calculates the first target control amount for the first axis attitude control mechanism of the flying vehicle based on the input image, and the first axis attitude controller manipulates the first axis attitude control mechanism to the positive side or the negative side based on the first target control amount. In addition, the first target control amount calculator recognizes the tracking target of the flying vehicle based on the input image, virtually sets a flight path on the input image based on the position of the tracking target in the input image, and calculates the first target control amount based on the first positive-side area value between the first control reference line and the first positive-side dividing line which is the positive-side boundary of the flight path, and the first negative-side area value between the first control reference line and the first negative-side dividing line which is the negative-side boundary of the flight path. Consequently, according to the present invention, since it is possible to calculate the first target control amount for the first axis attitude control mechanism of the flying vehicle by simply calculating the area value from the input image, it is possible to reduce the load on a computer handling such a computation.
(20) In the present invention, the second target control amount calculator calculates the second target control amount for the second axis attitude control mechanism of the flying vehicle based on the input image, and the second axis attitude controller manipulates the second axis attitude control mechanism to the positive side or the negative side based on the second target control amount. In addition, in the present invention, the second target control amount calculator calculates the second target control amount, based on the second positive-side area value between the second control reference line and the second positive-side dividing line which is a positive-side boundary of the flight path, and the second negative-side area value between the second control reference line and the second negative-side dividing line on the negative side of the flight path. Consequently, according to the present invention, since it is possible to calculate the second target control amount for the second axis attitude control mechanism of the flying vehicle, by simply calculating the area value from the input image, it is possible to reduce the load on the computer handling such a computation.
(21) In the present invention, the third target control amount calculator calculates the third target control amount for the third axis attitude control mechanism of the flying vehicle based on the input image, and the third axis attitude controller manipulates the third axis attitude control mechanism to the positive side or the negative side based on the third target control amount. In addition, in the present invention, the third target control amount calculator virtually sets the target attitude line on the input image based on the attitude of the tracking target in the input image, calculates the third area value between the third control reference line and the target attitude line determined virtually in the input image, and calculates the third target control amount based on the third area value. Consequently, according to the present invention, since it is possible to calculate the third target control amount for the third axis attitude control mechanism of the flying vehicle by simply calculating the area value from the input image, it is possible to reduce the load on the computer handling such a computation.

### BRIEF DESCRIPTION OF THE DRAWINGS

FIG. 1 is a diagram schematically showing the configuration of a vehicle equipped with a vehicle control device according to a first embodiment of the present invention;

FIG. 2 is a functional block diagram of a vehicle control device;

FIG. 3 is a flowchart showing a specific sequence of target steering amount calculation processing;

FIG. 4 is a view showing an example of an input image (case where recognizing dividing lines of both positive and negative sides is possible);

FIG. 5 is a flowchart showing a specific sequence of total area calculation processing in a target steering amount calculator;

FIG. 6 is a flowchart showing a specific sequence of one-side area calculation processing in a target steering amount calculator;

FIG. 7 is a view showing an example of an input image (case where recognition of only a positive side dividing line is possible);

FIG. 8 is a view showing an example of an input image (case where own vehicle travel path greatly curves to the positive side);

FIG. 9 is a view showing an example of an input image (case where a positive-side obstacle hiding a part of the positive-side dividing line exists);

FIG. 10 is a flowchart showing a specific sequence of target vehicle speed calculation processing;

FIG. 11 is a flowchart showing a specific sequence of total area calculation processing in a target vehicle speed calculator;

FIG. 12 is a view showing an example of an input image for illustrating the processing of FIG. 11;

FIG. 13 is a view showing an example of a speed table;

FIG. 14 is a view showing an example of an input image (case where own vehicle travel path curves to the negative side);

FIG. 15 is a view showing an example of an input image (case where own vehicle travel path curves to the positive side);

FIG. 16 is a view showing an example of an input image for illustrating a sequence of calculating a curvature parameter;

FIG. 17 is a flowchart showing a specific sequence of target vehicle speed calculation processing according to a second embodiment of the present invention;

FIG. 18 is a view showing an example of an input image for illustrating the processing of FIG. 17;

FIG. 19 is a view schematically showing the configuration of a flying vehicle equipped with a flying vehicle control device according to a third embodiment of the present invention;

FIG. 20 is a functional block diagram of a flying vehicle control device;

FIG. 21 is a flowchart showing a specific sequence of yaw angle target control amount calculation processing;

FIG. 22 is a view showing an example of an input image for illustrating the processing of FIG. 21;

FIG. 23 is a flowchart showing a specific sequence of pitch axis target control amount calculation processing;

FIG. 24 is a view showing an example of an input image for illustrating the processing of FIG. 23;

FIG. 25 is a flowchart showing a specific sequence of roll axis target control amount calculation processing; and

FIG. 26 is a view showing an example of an input image for illustrating the processing of FIG. 25.

### DETAILED DESCRIPTION OF THE INVENTION

### First Embodiment

Hereinafter, a vehicle control device according to a first embodiment of the present invention will be described while referencing the drawings.

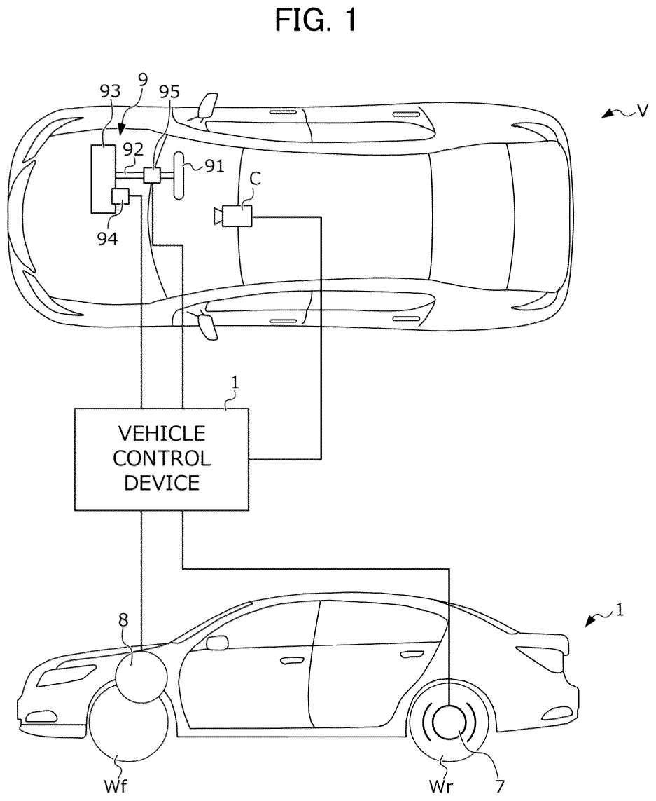

FIG. 1 is a view schematically showing the configuration of a vehicle V equipped with a vehicle control device 1 according to the present embodiment. The upper part of FIG. 1 shows a plan view of the vehicle V, and the lower part in FIG. 1 shows a side view. It should be noted that, hereinafter, a case where the vehicle V is a so-called right hand-drive four-wheeled vehicle in which the driver's seat on which the driver sits is provided on the right side in the vehicle-width direction viewed along the advancing direction; however, the present invention is not to be limited thereto. The vehicle V may be a so-called left-hand drive four-wheeled vehicle in which the driver's seat is provided on the left side in the vehicle-width direction viewed along the advancing direction.

The vehicle V includes: an electric power steering device 9 as a steering mechanism that steers left and right front wheels Wf; a power plant 8 as a traveling drive device that generates travel driving force to rotate the front wheels Wf, which are the drive wheels of the vehicle V; a braking device 7 that generates a braking force to stop rotation of the front wheels Wf and rear wheels Wr; an onboard camera C that captures images around the vehicle V; and a vehicle control device 1 that controls the electric power steering device 9, the power plant 8, and the braking device 7 based on images captured by the onboard camera C.

The electric power steering device 9 includes: a gearbox 93 that links a pinion shaft 92 extending from a steering wheel 91 which receives steering manipulations from the driver with the left and right front wheels Wf; an electric motor 94 provided to the gearbox 93; and a steering sensor 95 that detects a steering amount of the steering wheel 91.

The gearbox 93 includes a rack shaft extending along the vehicle-width direction and meshing with the pinion shaft 92, tie rods which connect both ends of a rack shaft with the left and right front wheels Wf, etc., and makes the left and right front wheels Wf steer to the advancing direction, by converting the rotational motion of the steering wheel 91 by the steering manipulation of the driver to motion along the vehicle-width direction. The electric motor 94 rotates in response to a control signal outputted from the vehicle control device 1, and generates driving force for assisting the steering manipulation by the driver, or automatically steering the front wheels Wf irrespective of the steering manipulation from the driver. The steering sensor 95 detects the steering amount of the steering wheel 91, and sends a signal according to a detection value to the vehicle control device 1. It should be noted that, hereinafter, a case will be described in which the steering amount when going straight is set as 0, the steering amount when turning right is set as a positive side, and the steering amount when turning left is set as a negative side; however, the present invention is not to be limited thereto. The steering amount when turning right may be set as the negative side, and the steering amount when turning left may be set as the positive side.

The power plant 8 is a drive power generation source that generates the travel driving force to make the front wheels Wf rotate in order to advance or reverse the vehicle V along the advancing direction, according to an acceleration-deceleration manipulation on the accelerator pedal (not shown) by the driver and a control signal outputted from the vehicle control device 1. Hereinafter, a case of using a drive motor to generate the travel driving force by consuming electricity supplied from a high-voltage battery, fuel cell stack or the like (not shown) as the power plant 8 will be described; however, the present invention is not to be limited thereto. The power plant 8 may use an engine that generates the travel driving force by consuming a fuel stored in a fuel tank (not shown), a transmission that gear reduces the output of this engine and transmits to the front wheels Wf.

The braking device 7 includes: a disk brake device that mainly generates braking force for decelerating or stopping rotation of each vehicle wheel Wf, Wr by clamping the disk provided to the axle of each wheel Wf, Wr during travel, based on a braking operation on a brake pedal (not shown) by the driver and a control signal outputted from the vehicle control device 1, and a parking brake that generates braking force mainly for maintaining the rotation of each wheel Wr, Wf in a stopped state during parking of the vehicle.

The onboard camera C is directed to the front side along the advancing direction viewed from the vehicle V. In addition, the present embodiment describes a case where the onboard camera C is provided at the center in the vehicle-width direction on the vehicle body of the vehicle V; however, the present invention is not limited thereto.

The vehicle control device 1 controls the electric power steering device 9, the power plant 8 and the braking device 7, based on images on the front side of the vehicle V captured by the onboard camera C. The vehicle control device 1 is a computer configured by hardware such as an arithmetic processing means such as a CPU, an auxiliary storage means such as HDD or SSD which stores programs to cause target steering amount calculation processing, target vehicle speed calculating processing, etc. described later to be executed in the arithmetic processing means; and a main storage means such as RAM for storing data which is temporarily necessitated upon the arithmetic processing means executing programs.

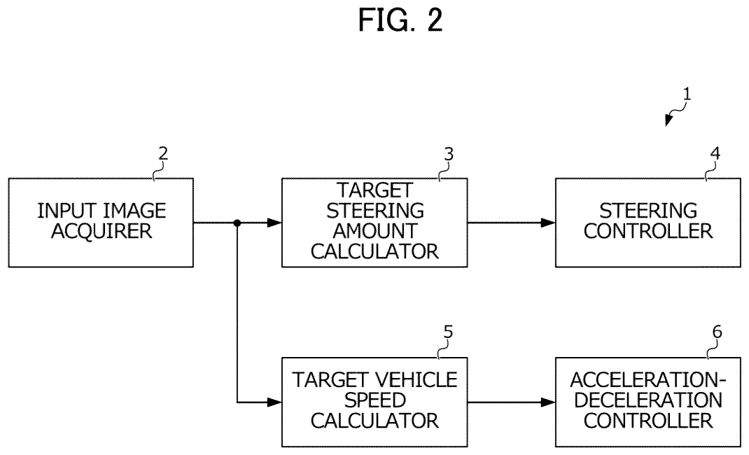

FIG. 2 is a functional block diagram of the vehicle control device 1. In the vehicle control device 1, the input image acquirer 2, target steering amount calculator 3, steering controller 4, target vehicle speed calculator 5 and acceleration-deceleration controller 6 are configured by the above such hardware.

The input image acquirer 2 acquires an image of the front side of the vehicle V captured by the onboard camera C as an input image. The input image acquirer 2 sends the acquired input image to the target steering amount calculator 3 and the target vehicle speed calculator 5.

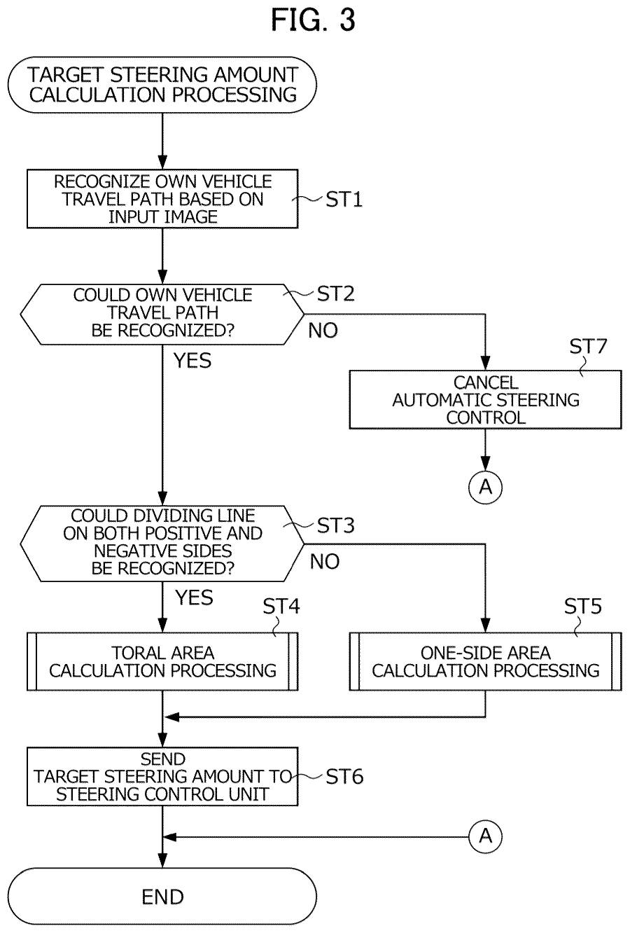

The target steering amount calculator 3 calculates the target steering amount for the steering amount of the electric power steering device 9, based on the input image sent from the input image acquirer 2. It should be noted that, a sequence of calculating the target steering amount based on the input image in the target steering amount calculator 3 will be described while referencing FIGS. 3 to 9, etc. later. The steering controller 4 executes automatic steering control to automatically manipulate the electric motor 94 of the electric power steering device 9, so that the target steering amount calculated by the target steering amount calculator 3 and the steering amount detected by the steering sensor 95 match.

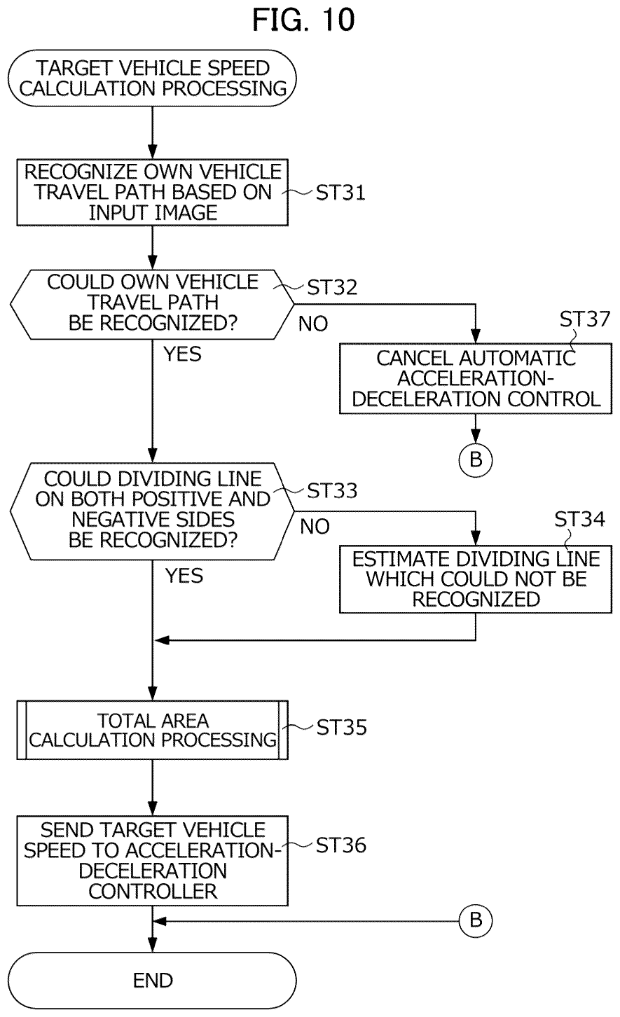

The target vehicle speed calculator 5 calculates the target vehicle speed for the vehicle speed of the vehicle V, based on the input image sent from the input image acquirer 2. It should be noted that a sequence of calculating the target vehicle speed based on the input image in the target vehicle speed calculator 5 will be described while referencing FIGS. 10 to 16, etc. later. The acceleration-deceleration controller 6 executes automatic acceleration-deceleration control to automatically manipulate the power plant 8 and the braking device 7, so that the target vehicle speed calculated by the target vehicle speed calculator 5 and the vehicle speed of the vehicle V detected by a vehicle speed sensor (not shown) match.

FIG. 3 is a flowchart showing a specific sequence of the target steering amount calculation processing of calculating the target steering amount based on the input image. This target steering amount calculation processing is executed by the target steering amount calculator 3 every time a new input image is acquired by the input image acquirer 2.

First, in Step ST1, the target steering amount calculator 3 recognizes the own vehicle travel path corresponding to a range in which travel of the vehicle V is allowed based on the input image, and then advances to Step ST2.

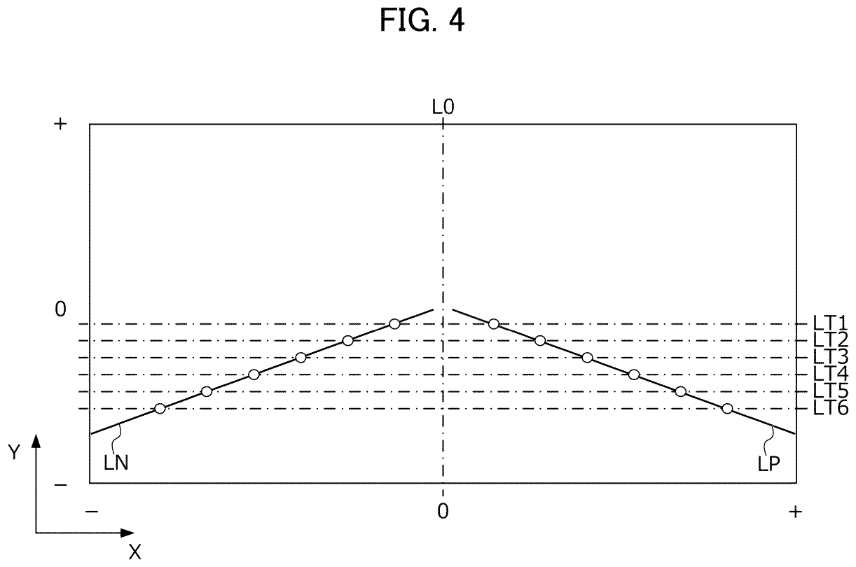

FIG. 4 is a view showing an example of an input image. It should be noted that, hereinafter, in accordance with the definition of the aforementioned such steering amount, the right side in the input image is referred to as a positive side, and the left side is referred to as a negative side. In addition, hereinafter, the horizontal axis extending in the width direction of the input image is defined as the X axis, and the vertical axis which is orthogonal to the X axis and extending in the up-down direction of the input image is defined as the Y axis. In addition, hereinafter, the center point of the input image is defined as the origin of the X axis and Y axis.

The target steering amount calculator 3 recognizes the own vehicle travel path by extracting a feature lines such as a white lines or curbs extending on both positive and negative sides (i.e. both left and right sides in FIG. 4) viewing from the vehicle V, from the inside the input image. More specifically, the target steering amount calculator 3 recognizes a feature line extending on the positive side (i.e. right side in FIG. 4) viewing from the vehicle V and longer than a predetermined length as a positive side dividing line (i.e. right-side dividing line in FIG. 4) LP corresponding to the positive side end (i.e. right end in FIG. 4) of the own vehicle travel path, and recognizes a feature line extending on the negative side (i.e. left side in FIG. 4) viewing from the vehicle V and longer than ta predetermined length, as a negative-side dividing line (i.e. left-side dividing line in FIG. 4) LN corresponding to the negative-side end (i.e. left end in FIG. 4) of the own vehicle travel path. Herein, the target steering amount calculator 3, in the case of a part of a feature line extracted from the input image being interrupted, may recognize the positive-side dividing line LP or negative-side dividing line LN by interpolating this feature line in accordance with a known algorithm.

The target steering amount calculator 3, in the case of being able to recognize both the positive-side dividing line LP and the negative-side dividing line LN from the input image, recognizes a region between this positive-side dividing line LP and negative-side dividing line LN in the input image as the own vehicle travel path. The target steering amount calculator 3, in the case of being able to recognize the positive-side dividing line LP and not being able to recognize the negative-side dividing line LN from the input image, recognizes the region on the negative side from the positive-side dividing line LP in the input image as the own vehicle travel path. In addition, the target steering amount calculator 3, in the case of being able to recognize the negative-side dividing line LN and not being able to recognize the positive-side dividing line LP from the input image, recognizes the region on the positive side from the negative-side dividing line LN in the input image as the own vehicle travel path.

Referring back to FIG. 3, in Step ST2, the target steering amount calculator 3 determines whether or not being able to recognize the own vehicle travel path from the input image in Step ST1. More specifically, the target steering amount calculator 3, in the case of being able to recognize at least any of the positive-side dividing line LP and the negative-side dividing line LN demarcating the own vehicle travel path from the input image, determines as being able to recognize the own vehicle travel path, and then advances to Step ST3. In addition, the target steering amount calculator 3, in the case of not being able to recognize both of the positive-side dividing line LP and the negative-side dividing line LN, determines as not being able to recognize the own vehicle travel path, and then advances to Step ST7. In addition, in Step ST7, the target steering amount calculator 3 cancels the automatic steering control by the steering controller 4, and ends the target steering amount calculation processing of FIG. 3.

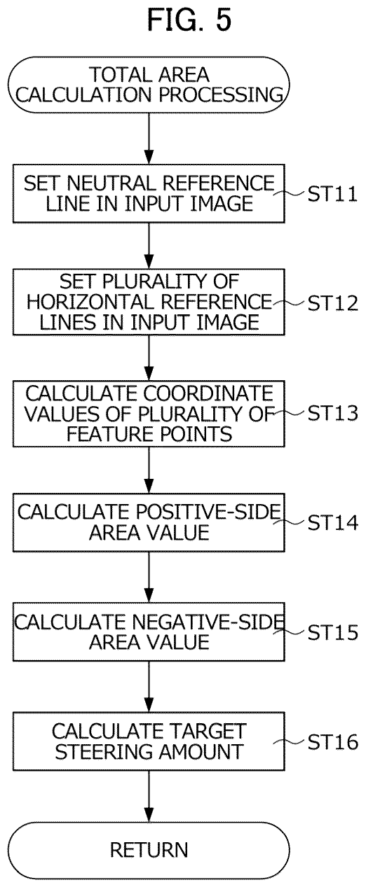

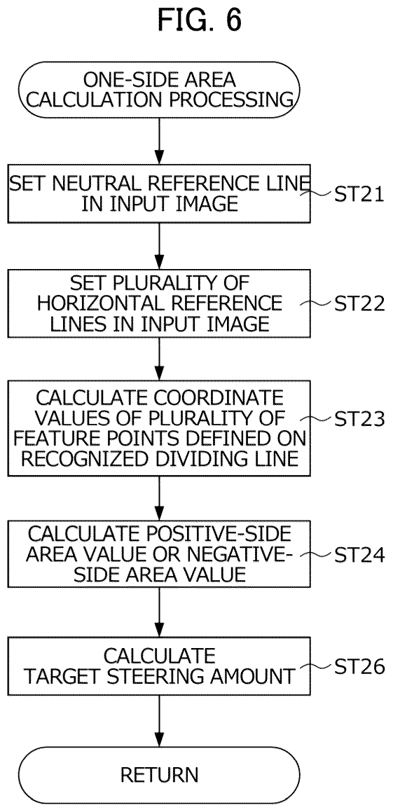

Next, in Step ST3, the target steering amount calculator 3 determines whether or not being able to recognize both the positive-side dividing line LP and negative-side dividing line LN. The target steering amount calculator 3, in the case of the determination result in Step ST3 being YES, i.e. case of being able to recognize the dividing lines LP, LN on both positive and negative sides, executes total area calculation processing described by referencing FIG. 5 (refer to Step ST4), and calculates the target steering amount according to the input image. In addition, the target steering amount calculator 3, in the case of the determination result in Step ST3 being NO, i.e. case of being able to recognize only one of either of the dividing lines LP, LN on both positive and negative sides, executes one-side area calculation processing described by referencing FIG. 6 (refer to Step ST5), and calculates the target steering amount according to the input image.

Next, in Step ST6, the target steering amount calculator 3 sends the target steering amount calculated by executing the total area calculation processing (Step ST4) or one-side area calculation processing (Step ST5) to the steering controller 4, and ends the target steering amount calculation processing of FIG. 3.

FIG. 5 is a flowchart showing a specific sequence of total area calculation processing in the target steering amount calculator 3. As mentioned above, this total area calculation processing is executed in the case of being able to recognize the dividing lines LP, LN on both positive and negative sides from the input image.

First, in Step ST11, the target steering amount calculator 3 virtually sets a neutral reference line L0 in the input image, and then advances to Step ST12. As mentioned above, the onboard camera C is provided at the center in the vehicle-width direction of the vehicle body. For this reason, the target steering amount calculator 3, in the case of causing the vehicle V to travel along with the own vehicle travel lane between the positive-side dividing line LP and the negative-side dividing line LN, preferably sets the neutral reference line L0 at the origin of the X axis (i.e. center in width direction of input image) as shown in FIG. 4. It should be noted that a case of the onboard camera C not being provided at the center in the width direction of the vehicle body will be described later.

In Step ST12, the target steering amount calculator 3 sets a plurality of (six in the example of FIG. 4) horizontal reference lines LT1, LT2, LT3, LT4, LT5, LT6 which intersect the neutral reference line L0 set in Step ST11, and parallel to each other, in the input image, and then advances to Step ST13. It should be noted that, hereinafter, a case is described where the target steering amount calculator 3 sets the plurality of horizontal reference lines LT1 to LT6 at equal intervals along the Y axis to intersect the neutral reference line L0 as shown in FIG. 4; however, the present invention is not limited thereto. These horizontal reference lines LT1 to LT6 may intersect at an angle other than 90 degrees relative to the neutral reference line L0, and may not necessarily be equal intervals. In addition, the target steering amount calculator 3 sets the plurality of horizontal reference lines LT1 to LT6 to be on a lower side of a vanishing point at which the interval along the X axis between the positive-side dividing line LP and the negative-side dividing line LN in the input image becomes substantially 0.

In Step ST13, the target steering amount calculator 3 establishes the intersection points between plurality of horizontal reference lines LT1 to LT6 set in the input image in Step ST12 and the positive-side dividing line LP and negative-side dividing line LN recognized from the input image as feature points, calculates the coordinate values of these feature points, and then advances to Step ST14. It should be noted that, hereinafter, the intersection points between the horizontal reference lines LT1 to LT6 and the positive-side dividing line LP are referred to as positive-side feature points, and the intersection points between the horizontal reference lines LT1 to LT6 and the negative-side dividing line LN are referred to as negative-side feature points.

In addition, hereinafter, the coordinate values of the i^{th} (i is an integer of 1 to 6) positive-side feature points (i.e. intersection point of i^{th} horizontal reference line LTi and positive-side dividing line LP) is expressed as (xpᵢ, ypᵢ), and coordinate values of the i^{th} negative-side feature point (i.e. intersection point of i^{th} horizontal reference line LTi and negative-side dividing line LN) is expressed as (xnᵢ, ynᵢ).

In Step ST14, the target steering amount calculator 3 calculates, as the positive-side area value, a value of the area of a region between the neutral reference line L0 and the positive-side dividing line LP in the input image, by using the coordinate values of the plurality of positive-side feature points calculated in Step ST13, and then advances to Step ST15. More specifically, the target steering amount calculator 3 defines the value of the area of a region surrounded by the positive-side dividing line LP, neutral reference line L0 and plurality of horizontal reference lines LT1 to LT6 in the input image as a positive-side area value Sp, and calculates this positive-side area value Sp by quadrature by parts as shown in Equation (1) below. It should be noted that, hereinafter, “a” refers to the coordinate value along the X axis of the neutral reference line L0.

$$Sp = {\sum }_{i} 0.5 ( ( - a + {xp}_{i} ) + ( - a + {xp}_{i + 1} ) ) \cdot ( {yp}_{i + 1} - {yp}_{i} ) \qquad ( 1 )$$

In Step ST15, the target steering amount calculator 3 calculates the value of the area of a region between the neutral reference line L0 and the negative-side dividing line LN in the input image, by using the coordinate values of the plurality of negative-side feature points calculated in Step ST13, as a negative-side area value, and then advances to Step ST16. More specifically, the target steering amount calculator 3 defines the value of the area of a region surrounded by the negative-side dividing line LN, neutral reference line L0 and plurality of horizontal reference lines LT1 to LT6 in the input image as a negative-side area value Sn, and calculates this negative-side area value Sn by quadrature by parts as shown in Equation (2) below.

$$Sn = {\sum }_{i} 0.5 ( ( a - {xn}_{i} ) + ( a - {xn}_{i + 1} ) ) \cdot ( {yn}_{i + 1} - {yn}_{i} ) \qquad ( 2 )$$

In Step ST16, the target steering amount calculator 3 calculates the target steering amount Str based on both the positive-side area value Sp and negative-side area value Sn calculated by the above such sequence, and then ends the total area calculation processing shown in FIG. 5. More specifically, the target steering amount calculator 3 calculates the target steering amount Str so as to be larger to the positive side as the positive-side area value Sp becomes larger, and so as to be larger to the negative side as the negative-side area value Sn becomes larger.

More specifically, the target steering amount calculator 3 calculates the target steering amount Str by dividing the difference (Sp−Sn) between the positive-side area value Sp and the negative-side area value Sn by the sum (Sp+Sn) of the positive-side area value Sp and the negative-side area value Sn, and then further multiplying by a gain Gain determined in advance, as shown in Equation (3) below. It should be noted that, hereinafter, a case of setting the gain Gain in Equation (3) below as a positive constant is described; however, the present invention is not limited thereto. The gain Gain may be established as a negative value. In addition, the value of this gain Gain may be varied according to the vehicle speed, arrangement pattern of feature points, or the like.

$$Str = Gain \cdot \frac{Sp - Sn}{Sp + Sn} \qquad ( 3 )$$

As shown in FIG. 4, the positive-side area value Sp becomes larger as the distance along the X axis between the neutral reference line L0 and the positive-side dividing line LP becomes longer, and the negative-side area value Sn becomes larger as the distance along the X axis between the neutral reference line L0 and the negative-side dividing line LN becomes longer. Therefore, by calculating the target steering amount Str in accordance with the above Equation (3), the target steering amount Str becomes larger to the positive side as the proportion of the positive-side area value Sp to the total area value (Sp+Sn) of the own vehicle travel path in the input image becomes larger, i.e. as the distance along the X axis between the neutral reference line L0 and the positive-side dividing line LP becomes longer. In addition, by making the target steering amount Str larger to the positive side, the neutral reference line L0 approaches the positive-side dividing line LP on the input image. In addition, by calculating the target steering amount Str in accordance with the above Equation (3), the target steering amount Str becomes larger to the negative side as the proportion of the negative-side area value Sn to the total area value (Sp+Sn) of the own vehicle travel path in the input image becomes larger, i.e. as the distance along the X axis between the neutral reference line L0 and the negative-side dividing line LN becomes longer. In addition, by making the target steering amount Str larger to the negative side, the neutral reference line L0 approaches the negative-side dividing line LN on the input image. For this reason, by calculating the target steering amount Str in accordance with the above Equation (3), the electric power steering device 9 can be automatically manipulated so that the positive-side area value Sp and the negative-side area value Sn become equal, i.e. so that the neutral reference line L0 is maintained at the center between the positive-side dividing line LP and the negative-side dividing line LN.

FIG. 6 is a flowchart showing a specific sequence of one-side area calculation processing in the target steering amount calculator 3. This one-side area calculation processing is executed in the case of being able to recognize only one among the dividing lines LP and LN on both positive and negative sides from the input image.

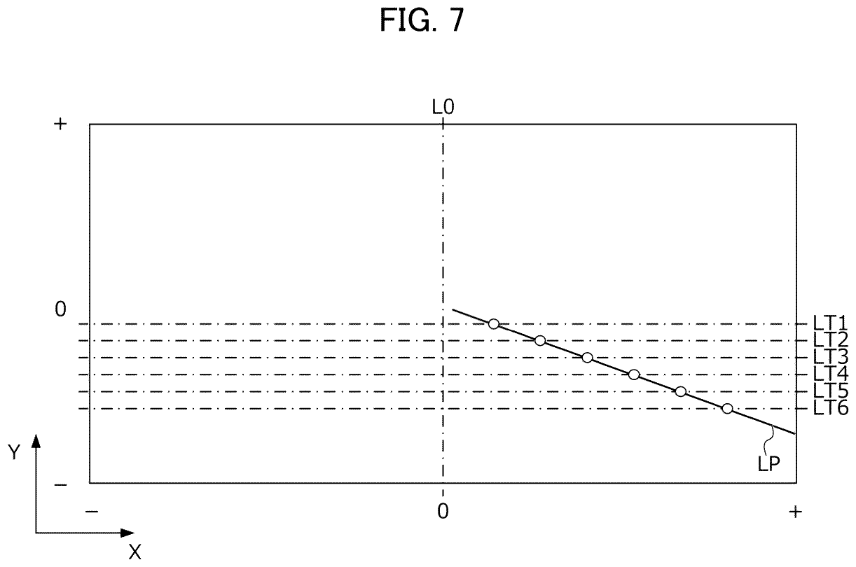

FIG. 7 is a view showing an example of an input image. It should be noted that FIG. 7 shows a case of being able to recognize the positive-side dividing line LP, and not being able to recognize the negative-side dividing line LN.

First, in Step ST21, the target steering amount calculator 3 virtually sets the neutral reference line L0 in the input image by the same sequence as Step ST11 in FIG. 5, and then advances to Step ST22.

In Step ST22, the target steering amount calculator 3 sets the plurality of horizontal reference lines LT1 to LT6 (six in the example of FIG. 5), by the same sequence of Step ST12 in FIG. 5, and then advances to Step ST23.

In Step ST23, the target steering amount calculator 3 calculates the coordinate values of a plurality of positive-side feature points and a plurality of negative-side feature points by the same sequence as Step ST13, and then advances to Step ST24. More specifically, the target steering amount calculator 3 calculates the coordinate values of the plurality of feature points defined on the dividing line recognized from the input image, and then advances to Step ST24. The intersection points of the plurality of horizontal reference lines LT1 to LT6 established in the input image in Step ST22 with the positive-side dividing line LP and negative-side dividing line LN recognized from the input image are defined as feature points, the coordinate values of these feature points are calculated, and then it advances to Step ST14. It should be noted that, hereinafter, the intersection points of the horizontal reference lines LT1 to LT6 with the positive-side dividing line LP are referred to as positive-side feature points, and the intersection points of the horizontal reference lines LT1 to LT6 with the negative-side dividing line LN are referred to as negative-side feature points.

In Step ST24, the target steering amount calculator 3 calculates either of the positive-side area value Sp and the negative-side area value Sn by the same sequence as Step ST14 or Step ST15, and then advances to Step ST26. More specifically, the target steering amount calculator 3 calculates the positive-side area value Sp by the same sequence as Step ST14, in the case of being able to recognize the positive-side dividing line LP from the input image. In addition, the target steering amount calculator 3 calculates the negative-side area value Sn by the same sequence as Step ST15, in the case of being able to recognize the negative-side dividing line LN from the input image.

In Step ST26, the target steering amount calculator 3 calculates the target steering amount Str based on either of the positive-side area value Sp and the negative-side area value Sn calculated by the above such sequence, and then ends the one-side area calculation processing shown in FIG. 6. More specifically, the target steering amount calculator 3 calculates the target steering amount Str, so as to become larger to the positive side as the positive-side area value Sp becomes larger, or so as to become larger to the negative side as the negative-side area value Sn becomes larger.

More specifically, the target steering amount calculator 3, in the case of calculating the positive-side area value Sp, calculates the target steering amount Str by dividing the difference (Sp−Sn_tmp) between the positive-side area value Sp and a predetermined negative-side reference value Sn_tmp by the sum (Sp+Sn_tmp) of the positive-side area value Sp and the negative-side reference value Sn_tmp, and then further multiplying by a gain Gain determined in advance, as shown in the following Equation (4). It should be noted that, hereinafter, a case of establishing the gain Gain in the following Equation (4) as a positive constant will be described; however, the present invention is not limited thereto. The gain Gain may be established as a negative value. In addition, the value of this gain Gain may be varied according to the vehicle speed, arrangement pattern of feature points, or the like.

$$Str = Gain \cdot \frac{Sp - Sn\_tmp}{Sp + Sn\_tmp} \qquad ( 4 )$$

In addition, the target steering amount calculator 3, in the case of calculating the negative-side area value Sn, calculates the target steering amount Str by dividing the difference (Sp_tmp−Sn) between a predetermined positive-side reference value Sp_tmp and the negative-side area value Sn by the sum (Sp_tmp+Sn) of the positive-side reference value Sp_tmp and the negative-side area value Sn, and then further multiplying by a gain Gain determined in advance, as shown in the following Equation (5). It should be noted that, hereinafter, a case of establishing the gain Gain in the following Equation (5) as a positive constant will be described; however, the present invention is not limited thereto. The gain Gain may be established as a negative value. In addition, the value of this gain Gain may be varied according to the vehicle speed, arrangement pattern of feature points, or the like.

$$Str = Gain \cdot \frac{Sp\_tmp - Sn}{Sp\_tmp + Sn} \qquad ( 5 )$$

Herein, the target steering amount calculator 3, in the case of not being able to recognize the negative-side dividing line LN from the input image, may set the negative-side area value Sn calculated from the input image at the time when able to recognize the negative-side dividing line LN as the negative-side reference value Sn_tmp. In addition, the target steering amount calculator 3, in the case of not being able to recognize the positive-side dividing line LP from the input image, may set the positive-side area value Sp calculated from the input image at the time when able to recognize the positive-side dividing line LP as the positive-side reference value Sp_tmp. In addition, the target steering amount calculator 3, in the case of being able to acquire the width of the own vehicle travel path while traveling based on map information (not shown), may set the negative-side reference value Sn_tmp or positive-side reference value Sp_tmp based on the width of this own vehicle travel path.

According to the above such one-side area calculation processing, it is possible to automatically manipulate the electric power steering device 9 so that the neutral reference line L0 is maintained at the center between the positive-side dividing line LP and the negative-side dividing line LN, for the same reason as the total area calculation processing shown in FIG. 5.

A specific sequence of the total area calculation processing and the one-side area calculation processing in the target steering amount calculator 3 according to the present embodiment has been described above with a case of the own vehicle travel path being a straight line as shown in FIG. 4 or 7 as an example: however, the present invention is also applicable to a case of the own vehicle travel path curving greatly.

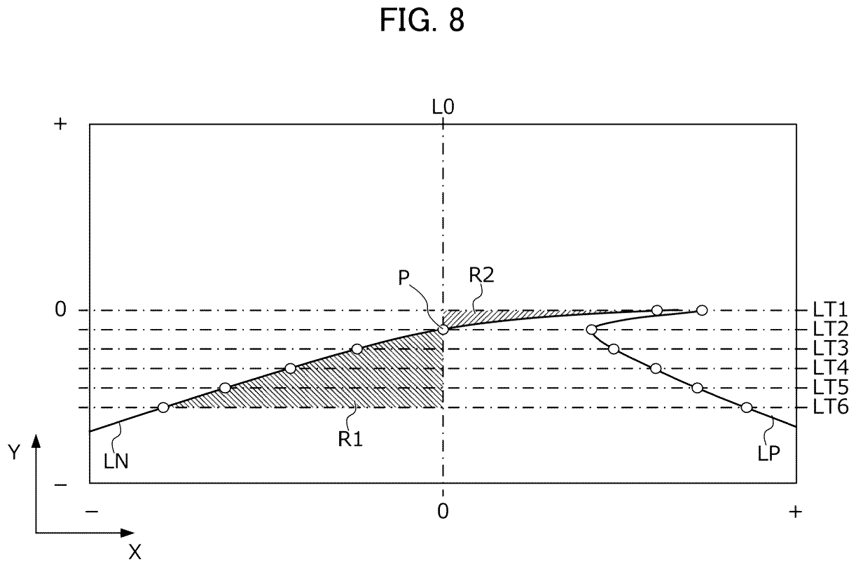

FIG. 8 is a view showing an example of the input image. More specifically, FIG. 8 shows a case of the own vehicle travel path greatly curving to the positive side.

As shown in FIG. 8, in the case of the own vehicle travel path curving greatly to the positive side, the negative-side dividing line LN and the neutral reference line L0 intersect in the input image. The target steering amount calculator 3, in the case of the negative-side dividing line LN and the neutral reference line L0 intersecting in the input image, calculates the negative-side area value Sn by subtracting the value of the area of the region R2 between a portion of the neutral reference line L0 above the intersection point P with the negative-side dividing line LN and the negative-side dividing line LN, from the value of the area of the region R1 between a portion of the neutral reference line L0 lower than the intersection point P, and the negative-side dividing line LN, by the processing of Step ST15 in FIG. 5 or Step ST24 in FIG. 6.

In addition, although omitted from illustration, this also applies to a case of the own vehicle travel path greatly curving to the negative side. In other words, the target steering amount calculator 3, in the case of the positive-side dividing line LP and the neutral reference line L0 intersecting in the input image, calculates the positive-side area value Sp by subtracting the value of the area of a region between a portion of the neutral reference line L0 on an upper side from the intersection point and the positive-side dividing line LP from the value of area of the region between a portion of the neutral reference line L0 on a lower side from the intersection point with the positive-side dividing line LP and the positive-side dividing line LP, by the processing in Step ST14 in FIG. 5 or Step ST24 in FIG. 6.

In the case of the own vehicle travel path greatly curving to the positive side or the negative side, the target steering amount calculator 3 can prompt a steering manipulation to the direction where the own vehicle travel path curves, by calculating the positive-side area value Sp and the negative-side area value Sn by the above such sequence.

In addition, in the aforementioned total area calculation processing and the one-side area calculation processing, a case is described in which the target steering amount calculator 3 assumes a case of causing the vehicle V to travel along in the own vehicle travel lane, and fixing the position of the neutral reference line L0; however, the present invention is not limited thereto. The target steering amount calculator 3, in the case of causing the vehicle V to travel from the own vehicle travel lane towards a positive-side adjacent travel lane which is adjacent to the positive-side dividing line LP, preferably causes the neutral reference line L0 to move from the center in the width-direction in the input image to the positive side at a predetermined speed in the processing of Step ST11 in FIG. 5 or Step ST21 in FIG. 6. In addition, the target steering amount calculator 3, in the case of causing the vehicle V to travel from the own vehicle travel lane to a negative-side adjacent travel lane which is adjacent to the negative-side dividing line LN, preferably causes the neutral reference line L0 to move from the center in the width-direction to the negative side at a predetermined speed in the processing of Step ST11 in FIG. 5 or Step ST21 in FIG. 6.

In addition, in Step ST11 of the aforementioned total area calculation processing and Step ST21 of the one-side area calculation processing, a case has been described premised on the onboard camera C being provided at the center in the width direction of the vehicle body, in which the neutral reference line L0 is set at the center in the width direction of the input image; however, the present invention is not limited thereto. There are also cases where the onboard camera C is provided at a position deviated from the center in the width direction of the vehicle body. In such a case, the target steering amount calculator 3 stores, as the center position, the position in the input image of the neutral reference line L0 at which the positive-side area value Sp and the negative-side area value Sn defined as mentioned above are made equal, when the vehicle V is traveling in the center in the width direction of a straight road. Subsequently, the target steering amount calculator 3, in the case of causing the vehicle V to travel along within the own vehicle travel lane, preferably sets the neutral reference line L0 at a stored neutral position in the Step ST11 of the total area calculation processing, or Step ST21 of the one-side area calculation processing.

In addition, in the aforementioned target steering amount calculation processing, a case has been described of the target steering amount calculator 3 recognizing the feature lines such as the white lines and curbs extracted from within the input image, as the positive-side dividing line LP or the negative-side dividing line LN; however, the present invention is not limited thereto.

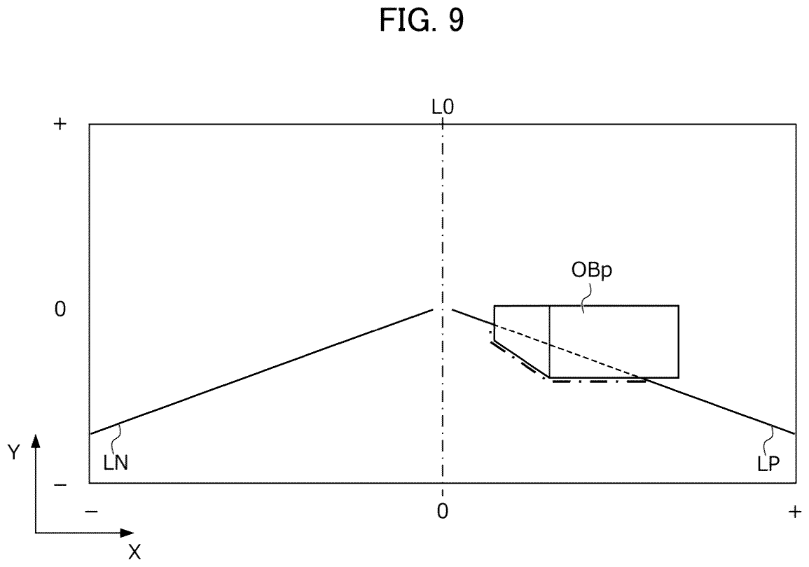

FIG. 9 is a view showing an example of an input image. FIG. 9 shows a case of a positive-side obstacle (e.g., vehicle stopped on roadside) OBp hiding part of the positive-side dividing line LP existing at a position on the positive side somewhat ahead viewed from the vehicle V. In such a case, it is preferable to steer the vehicle V to the negative side for the vehicle V to avoid the positive-side obstacle OBp.

The target steering amount calculator 3, in the processing of Step ST1, in the case of recognizing the positive-side dividing line LP and a positive-side obstacle OBp hiding a part thereof based on the input image, preferably interpolates a portion of the positive-side dividing line LP hidden by the position-side obstacle OBp (position indicated by dotted line in FIG. 9), by a line along the lateral face on the negative side of the positive-side obstacle OBp as shown by the bold single dot chained line in FIG. 9. As shown in FIG. 9, by interpolating the portion of the positive-side dividing line LP hidden by the positive-side obstacle OBp by the bold single-dot chain line, since it is possible to make the positive-side area value Sp smaller than the case of interpolating by the dotted line, it is possible to make the vehicle V steer to the negative side so that the vehicle V avoids the positive-side obstacle OBp.

It should be noted that, although omitted from illustration, it also applies to a case of a negative-side obstacle hiding a part of the negative-side dividing line LN existing at a position on the negative side somewhat ahead viewing from the vehicle V. In other words, in the processing of Step ST1, the target steering amount calculator 3, in the case of recognizing the negative-side dividing line LN and a negative-side obstacle hiding a part thereof based on the input image, preferably interpolates the portion of the negative-side dividing line LP hidden by the negative-side obstacle by a line along the lateral face on the positive side of the negative-side obstacle. It is thereby possible to make the vehicle V steer to the positive side so that the vehicle V avoids the negative-side obstacle.

It should be noted that such avoidance of obstacles hiding the dividing lines can also be realized by moving the neutral reference line L0. In other words, the target steering amount calculator 3, in the case of recognizing the positive-side dividing line LP and the positive-side obstacle OBp hiding a part thereof based on the input image in the processing of Step ST1, may move the position of the neutral reference line L0 in the input image from the origin of the X axis to the negative side in Step ST11 or Step ST21. It is thereby possible to cause the vehicle V to steer to the negative side so that the vehicle V avoids the positive-side obstacle OBp. In addition, the target steering amount calculator 3, in the case of recognizing the negative-side dividing line LN and a negative-side obstacle hiding a part thereof based on the input image in the processing of Step ST1, may move the position of the neutral reference line L0 in the input image from the origin of the X axis to the positive side in Step ST11 or Step ST21. It is thereby possible to cause the vehicle V to steer to the positive side so that the vehicle V avoids the negative-side obstacle.

In addition, in the aforementioned target steering amount calculation processing, a case has been described of the target steering amount calculator 3 executing the total area calculation processing when able to recognize both positive and negative side dividing lines LP, LN from the input image (Step ST4), and executing the one-side area calculation processing when able to recognize only either one of both positive and negative side dividing lines LP, LN (Step ST5); however, the present invention is not limited thereto.

More specifically, the target steering amount calculator 3, in the case of being able to recognize the positive-side dividing line LP and not being able to recognize the negative-side dividing line LN in the processing of Step ST1, may execute total area calculation processing by estimating the negative-side dividing line LN based on the shape in the input image of the recognized positive-side dividing line LP, and further using this recognized positive-side dividing line LP and estimated negative-side dividing line LN. In addition, the target steering amount calculator 3, in the case of being able to recognize the negative-side dividing line LN and not being able to recognize the positive-side dividing line LP in the processing of Step ST1, may execute the total area calculation processing by estimating the positive-side dividing line LP based on the shape in the input image of the recognized negative-side dividing line LN, and further using this recognized negative-side dividing line LN and estimated positive-side dividing line LP.

FIG. 10 is a flowchart showing a specific sequence of the target vehicle speed calculation processing of calculating the target vehicle speed based on input images. This target vehicle speed calculation processing is executed by the target vehicle speed calculator 5 every time a new input image is acquired by the input image acquirer 2.

First, in Step ST31, the target vehicle speed calculator 5 recognizes the own vehicle travel path based on the input image, and then advances to Step ST32. It should be noted that the sequence of recognizing the own vehicle travel path, the positive-side dividing line LP, negative-side dividing line LN, etc. corresponding to the boundaries thereof from the input image in the target vehicle speed calculator 5 is the same as the sequence of processing in the target steering amount calculator 3 (e.g., Step ST1); therefore, detailed descriptions thereof will be omitted.

In Step ST32, the target vehicle speed calculator 5 determines whether or not able to recognize the own vehicle travel path from the input image in Step ST31. It should be noted that the sequence of determining whether or not able to recognize the own vehicle travel path from the input image in the target vehicle speed calculator 5 is the same as the sequence of processing in the target steering amount calculator 3 (e.g., Step ST2); therefore, detailed descriptions thereof will be omitted. The target vehicle speed calculator 5, in the case of the determination result in Step ST32 being YES, advances to Step ST33, and in the case of the determination result in Step ST32 being NO, advances to Step ST37. In addition, in Step ST37, the target vehicle speed calculator 5 cancels the automatic acceleration-deceleration control by the acceleration-deceleration controller 6, and ends the target vehicle speed calculation processing of FIG. 10.

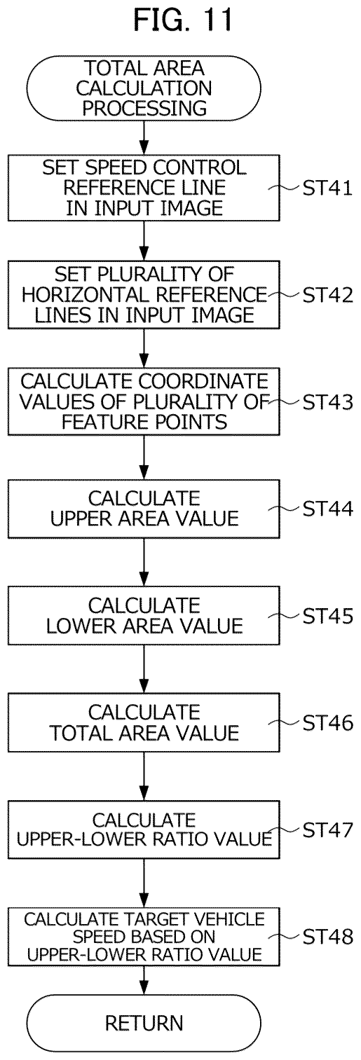

Next, in Step ST33, the target vehicle speed calculator 5 determines whether or not able to recognize both the positive-side dividing line LP and negative-side dividing line LN. The target vehicle speed calculator 5, in the case of the determination result in Step ST33 being YES, i.e. case of being able to recognize both the positive and negative side dividing lines LP, LN, executes the total area calculation processing described by referencing FIG. 11 (refer to Step ST35), calculates the target vehicle speed according to the input image, and then advances to Step ST36. In addition, the target vehicle speed calculator 5, in the case of the determination result in Step ST33 being NO, i.e. case of only being able to recognize either one among both the positive and negative side dividing lines LP, LN, advances to Step ST34.

Next, in Step ST36, the target vehicle speed calculator 5 sends the target vehicle speed calculated by executing the total area calculation processing (Step ST34) or the one-side area calculation processing (Step ST35) to the acceleration-deceleration controller 6, and then ends the target vehicle speed calculation processing of FIG. 10.

FIG. 11 is a flowchart showing a specific sequence of the total area calculation processing in the target vehicle speed calculator 5. In the above way, this total area calculation processing is executed in the case of being able to recognize both the positive and negative side dividing lines LP, LN from the input image.

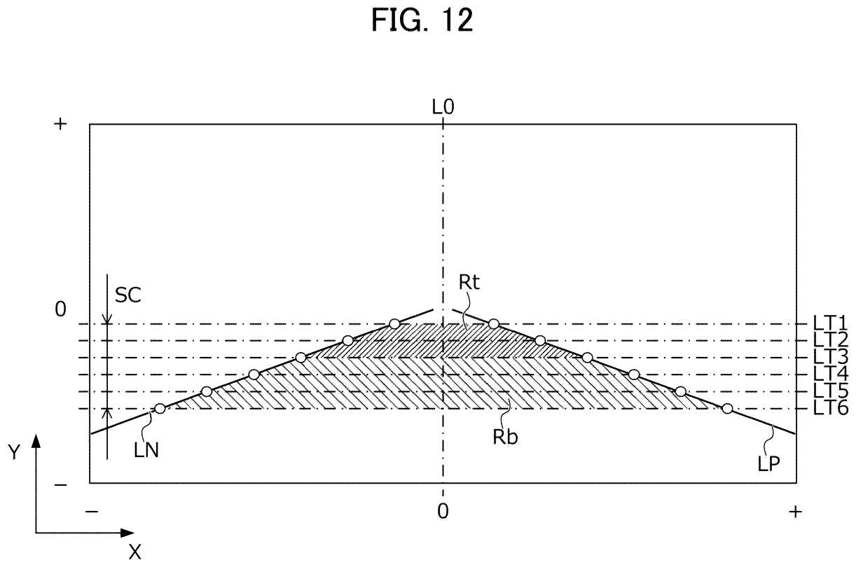

FIG. 12 is a view showing an example of the input image. Hereinafter, a specific sequence of the total area calculation processing of FIG. 11 will be described with the input image shown in FIG. 12 as an example.

First, in Step ST41, the target vehicle speed calculator 5 virtually sets the vehicle speed control reference line LT3 extending in parallel to the X axis relative to the input image (i.e. width direction of input image), and then advances to Step ST42. More specifically, the target vehicle speed calculator 5 virtually sets a horizontal reference line setting interval of a predetermined length SC on the Y axis, and further sets a speed control reference line L3 at a position internally dividing this horizontal reference line setting interval vertically by a predetermined internal division ratio (upper interval length:lower internal length=2:3 in example of FIG. 12). In addition, at this time, the target vehicle speed calculator 5 preferably sets the horizontal reference line setting interval of the length SC to within the interval in which both or either one of the positive-side dividing line LP and the negative-side dividing line LN is defined on the Y axis.

Next, in Step ST42, the target vehicle speed calculator 5 sets the plurality of horizontal reference lines LT1, LT2, LT4, LT5, LT6 (five in example of FIG. 12) parallel to the speed control reference line LT3 set in Step ST41 within the input image, to within the aforementioned horizontal reference line setting interval, and then advances to Step ST43. Herein, in the target vehicle speed calculator 5, a ratio in the horizontal reference line setting interval of the number of the horizontal reference lines set in an upper interval to the number of the horizontal reference lines set in a lower interval is preferably equal to the aforementioned internal division ratio. Therefore, in the example shown in FIG. 12, the two of the horizontal reference lines LT1 and LT2 are set at positions more to the positive side along the Y axis than the speed control reference line LT3 set in Step ST41, and the three of the horizontal reference lines LT4, LT5 and LT6 are set at positions more to the negative side along the Y axis than the speed control reference line LT3. It should be noted that, hereinafter, a case of the target vehicle speed calculator 5 setting the plurality of horizontal reference lines LT1, LT2, LT4, LT5, LT6 and speed control reference line LT3 at equal intervals along the Y axis as shown in FIG. 12 will be described; however, the present invention is not limited thereto. In addition, hereinafter, for convenience of calculation, the speed control reference line LT3 is also referred to as the third horizontal reference line.

In Step ST43, the target vehicle speed calculator 5 defines the intersection points of the plurality of horizontal reference lines LT1 to LT6 set in the input image in Step ST42 with the positive-side dividing line LP and negative-side dividing line LN recognized from the input image as feature points, calculates the coordinate values of these feature points, and then advances to Step ST44. It should be noted that, hereinafter, the intersection points of the horizontal reference lines LT1 to LT6 with the positive-side dividing line LP are referred to as positive-side feature points, and the intersection points of the horizontal reference lines LT1 to LT6 with the negative-side dividing line LN are referred to as negative-side feature points.

In addition, hereinafter, the coordinate value of an i^{th} (i is an integer of 1 to 6) positive-side feature point (i.e. intersection point between i^{th} horizontal reference line LTi and positive-side dividing line LP) is expressed as (xpᵢ, ypᵢ), and the coordinate value of the i^{th} negative-side feature point (i.e. intersection point between i^{th} horizontal reference line LTi and negative-side dividing line LN) is expressed as (xnᵢ, ynᵢ).

In Step ST44, the target vehicle speed calculator 5 calculates the value of the area of the own vehicle travel path on the upper side from the speed control reference line LT3 in the input image, as the upper area value, by using the coordinate values of the plurality of positive-side feature points and the negative-side feature points calculated in Step ST43, and then advances to Step ST45. More specifically, the target steering amount calculator 3 establishes the value of the area of the region Rt surrounded by the positive-side dividing line LP, negative-side dividing line LN, speed control reference line LT3 and plurality of horizontal reference lines LT1 and LT2 in the input image as an upper area value St, and calculates this upper area value St by quadrature by parts as shown in the following Equation (6).

$$St = {\sum }_{i = 1}^{2} 0.5 ( ( {xp}_{i + 1} - {xn}_{i + 1} ) + ( {xp}_{i} - {xn}_{i} ) ) \cdot ( {yp}_{i} - {yp}_{i + 1} ) \qquad ( 6 )$$

In Step ST45, the target vehicle speed calculator 5 calculates the value of the area of the own vehicle travel path on the lower side from the speed control reference line LT3 in the input image as the lower area value, by using the coordinate values of the plurality of positive-side feature points and negative-side feature points calculated in Step ST43, and then advances to Step ST46. More specifically, the target steering amount calculator 3 establishes the value of the area of the region Rb surrounded by the positive-side dividing line LP, negative-side dividing line LN, speed control reference line LT3 and plurality of horizontal reference lines LT4 to LT6 in the input image as a lower area value Sb, and calculates this lower area value Sb by quadrature by parts as shown in the following Equation (7).

$$Sb = {\sum }_{i = 3}^{3} 0.5 ( ( {xp}_{i + 1} - {xn}_{i + 1} ) + ( {xp}_{i} - {xn}_{i} ) ) \cdot ( {yp}_{i} - {yp}_{i + 1} ) \qquad ( 7 )$$

In Step ST46, the target vehicle speed calculator 5 calculates the sum of the upper area value St and the lower area value Sb as the total area value Stotal (=St+Sb), and then advances to Step ST47.

In Step ST47, the target vehicle speed calculator 5 calculates the value of the ratio of the upper area value St relative to the total area value Stotal as an upper-lower ratio value r (=St/Stotal), and then advances to Step ST48.

In Step ST48, the target vehicle speed calculator 5 calculates the target speed Vtrgt based on the upper-lower ratio value r calculated by the above such sequence, and then ends the total area calculation processing of FIG. 11. More specifically, the target vehicle speed calculator 5 reads a speed table associating the upper-lower ratio value r and target vehicle speed Vtrgt from a storage medium (not shown), and calculates the target vehicle speed Vtrgt according to the upper-lower ratio value r by searching the read speed table based on the upper-lower ratio value r calculated in Step ST47.

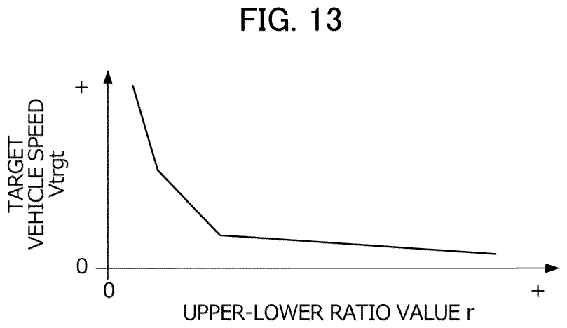

FIG. 13 is a view showing an example of the speed table. According to the speed table such as that shown in FIG. 13, the target vehicle speed calculator 5 calculates the target vehicle speed Vtrgt so as to become smaller as the upper-lower ratio value r becomes larger.

Herein, since the onboard camera C captures the front side of the vehicle V from a higher position than the road surface, a case of the own vehicle travel path curving ahead to the positive side or the negative side has a larger area of the own vehicle travel path far away in the input image than a case of the own vehicle travel path being straight ahead. In other words, there is a tendency of the case of the own vehicle travel path curving ahead to the positive side or negative side having a larger upper-lower ratio value r than a case of the own vehicle travel path being straight ahead. Therefore, the target vehicle speed calculator 5 can calculate the target vehicle speed Vtrgt according to the own vehicle travel path by a simple computation, by calculating the target vehicle speed Vtrgt so as to become smaller as the upper-lower ratio value r becomes larger.

Referring back to FIG. 10, in Step ST34, the target vehicle speed calculator 5 estimates the dividing which could not be recognized among both positive and negative side dividing lines LP, LN, based on the shape in the input image of the dividing line which could be recognized, and then advances to Step ST35. More specifically, the target vehicle speed calculator 5 estimates the negative-side dividing line LN, based on the shape in the input image of the positive-side dividing line LP which could be recognized, in the case of being able to recognize positive-side dividing line LP and not being able to recognize the negative-side dividing line LN based on the input image. More specifically, the target vehicle speed calculator 5 estimates the negative-side dividing line LN so as to be parallel to the positive-side dividing line LP when viewed from above. In addition, the target vehicle speed calculator 5 estimates the positive-side dividing line LP based on the shape in the input image of the negative-side dividing line LN which could be recognized, in the case of being able to recognize the negative-side dividing line LN and not being able to recognize the positive-side dividing line LP based on the input image. More specifically, the target vehicle speed calculator 5 estimates the positive-side dividing line LP so as to be parallel to the negative-side dividing line LN when viewed from above.

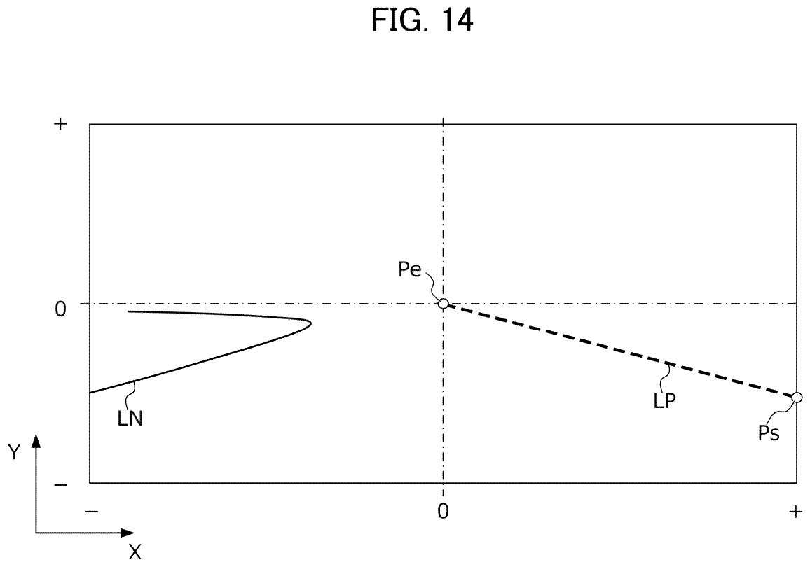

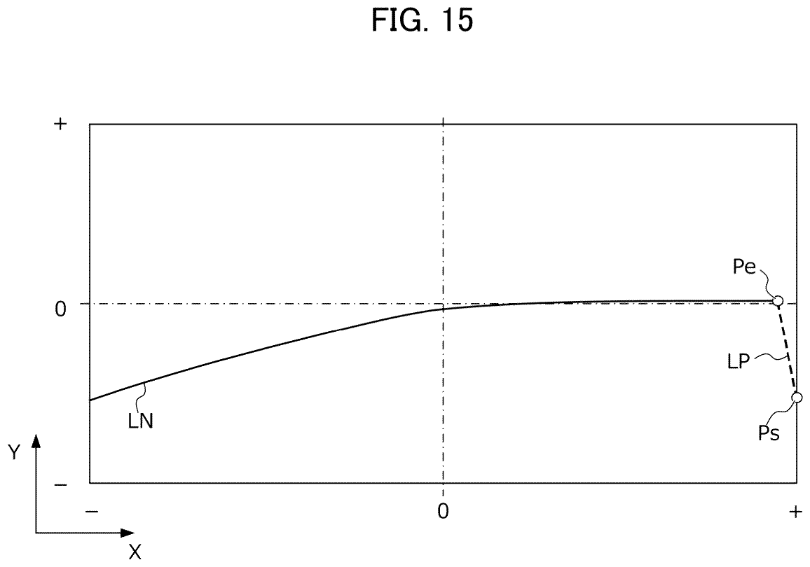

Next, based on the shape in the input image of either one of the dividing lines among both positive and negative side dividing lines LP, LN a specific sequence of estimating the other dividing line in the target vehicle speed calculator 5 will be described while referencing FIGS. 14 and 15.

FIG. 14 is a view showing an example of an input image. More specifically, FIG. 14 shows a case of the own vehicle travel path curving to the negative side. In addition, hereinafter, a case will be described of the target vehicle speed calculator 5 being able to recognize the negative-side dividing line LN which bends to the negative side, but not being able to recognize the positive-side dividing line LP, based on the input image shown in FIG. 14.

The target vehicle speed calculator 5, in the case of the negative-side dividing line LN recognized from the input image bending to the negative side, establishes a virtual line (refer to bold dashed line in FIG. 14) passing through the two of the start point Ps and the end point Pe determined within the input image as the positive-side dividing line LP. It should be noted that, in this case, the start point Ps of the virtual line, for example, is set at a position reversing the sign of the X-axis component of the coordinate value at the lower end in the input image of the negative-side dividing line LN which is recognized. In addition, the end point Pe of the virtual line is set at the origin of the input image, for example.

Although a case of not being able to recognize the positive-side dividing line LP was described above by referencing FIG. 14, the same also applies to a case of not being able to recognize the negative-side dividing line LN. In other words, the target vehicle speed calculator 5 establishes a virtual line passing through the two of the start point Ps and the end point Pe determined within the input image as the negative-side dividing line LN, in the case of the positive-side dividing line LP recognized from the input image bending to the positive side. It should be noted that, in this case, the start point Ps of the virtual line, for example, is set at a position reversing the sign of the X-axis component of the coordinate values at the lower end in the input image of the positive-side dividing line LP which is recognized. In addition, the end point Pe of the virtual line is set at the origin of the input image, for example.

FIG. 15 is a view showing an example of an input image. More specifically, FIG. 15 shows a case of the own vehicle travel path curving to the positive side. In addition, hereinafter, a case is described of the target vehicle speed calculator 5 being able to recognize the negative-side dividing line LN bending to the positive side based on the input image shown in FIG. 15, but not being able to recognize the positive-side dividing line LP.

The target vehicle speed calculator 5, in the case of the negative-side dividing line LN recognized from the input image bending to the positive side, establishes the virtual line passing through the two of the start point Ps and the end point Pe determined within the input image (refer to bold dashed line in FIG. 15) as the positive-side dividing line LP. It should be noted that, in this case, the start point Ps of the virtual line, for example, is set at a position reversing the sign of the X-axis component of the coordinate values at the lower end in the input image of the negative-side dividing line LN which is recognized. In addition, the end point Pe of the virtual line is set at the same position as the upper end in the input image of the negative-side dividing line LN which is recognized.

Although a case of not being able to recognize the positive-side dividing line LP has been described above by referencing FIG. 15, the same also applies to the case of not being able to recognize the negative-side dividing line LN. In other words, the target vehicle speed calculator 5, in the case of the positive-side dividing line LP recognized from the input image bending to the negative side, establishes a virtual line passing through the two of the start point Ps and the end point Pe determined within the input image as the negative-side dividing line LN. It should be noted that, in this case, the start point Ps of the virtual line, for example, is set at a position reversing the sign of the X-axis component of the coordinate values at the lower end in the input image of the positive-side dividing line LP which is recognized. In addition, the end point Pe of the virtual line is set at the same position as the upper end in the input image of the positive-side dividing line LP which is recognized, for example.

Referring back to FIG. 10, in Step ST34, the target vehicle speed calculator 5, in the case of not being able to recognize either one of the dividing lines among both the positive and negative side dividing lines LP, LN, estimates the dividing line which could not be recognized by the above such sequence, and executes the aforementioned total area calculation processing (refer to Step ST35) using this estimated dividing line.

Although a specific sequence of the total area calculation processing in the target vehicle speed calculator 5 according to the present embodiment has been described above, the present invention is not limited thereto. For example, in Step ST48, the target vehicle speed calculator 5 calculates a target vehicle speed based on a single speed table such as that shown in FIG. 13; however, the present invention is not limited thereto. For example, the storage medium stores a plurality of speed tables associating the upper-lower ratio value and the target vehicle speed, and the target vehicle speed calculator 5 may switch the speed table according to various conditions.

For example, the target vehicle speed calculator 5 may estimate a curvature parameter of the own vehicle travel path ahead of the vehicle V based on the input image in accordance with the sequence described below, select one among the plurality of speed tables based on the estimated curvature parameter, and calculate the target vehicle speed based on the selected speed table and the upper-lower ratio value.

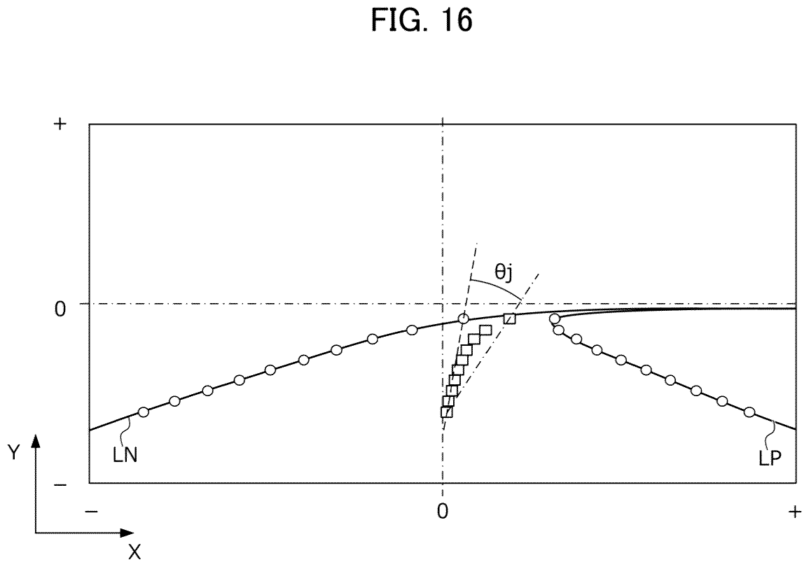

FIG. 16 is a view showing an example of an input image. It should be noted that FIG. 16 shows a case of the own vehicle travel path curving to the positive side ahead. Hereinafter, a sequence of calculating the curvature parameter in the target vehicle speed calculator 5 will be described while referencing FIG. 16.

The target vehicle speed calculator 5 calculates the coordinate values of a plurality of average feature points such as those indicated by the square symbols in FIG. 16, by using the coordinate values of the plurality of positive-side feature points and negative-side feature points acquired in Step ST43. Herein, a coordinate value xmidⱼ along the X axis of the j^{th} average feature point (j is an integer of 1 or more) counting from the lower side in order in the input image is defined by the following Equation (8). In the following Equation (8), “xpⱼ” is a coordinate value along the X axis of the j^{th} positive-side feature point counting in order from the lower side in the input image, and “xnⱼ” is a coordinate value along the X axis of the j^{th} negative-side feature point counting in order from the lower side in the input image.

$${xmid}_{j} = ( {xp}_{j} + {xn}_{j} ) / 2 \qquad ( 8 )$$

Next, the target vehicle speed calculator 5 virtually sets a reference line (refer to dashed line in FIG. 16) passing through the first and second average feature points (two average feature points closest to the vehicle V when viewed from above) in the input image. In addition, the target vehicle speed calculator 5 calculates an angle relative to the reference line for every average feature point. Herein, the angle θj of the j^{th} average feature point relative to the reference line refers to the angle of a line passing through the j^{th} average feature point and the first average feature point relative to the reference line, as shown in FIG. 16. In addition, the target vehicle speed calculator 5 calculates the curvature parameter Gall, by calculating the sum total of the absolute value of the angle relative to the reference line calculated relative to all average feature points, as shown in the following Equation (9). It is thereby possible to calculate the curvature parameter which increases proportional to the curvature of the own vehicle travel path by a simple computation from the input image.

$$θ all = {\sum }_{j} \vert θ j \vert \qquad ( 9 )$$

In addition, in the case of a plurality of travel modes which can be designated by the crew being determined in the vehicle V, the target vehicle speed calculator 5 may acquire the travel mode designed by the crew, select one from among a plurality of speed tables based on the acquired travel mode, and calculate the target vehicle speed based on the selected speed table and the upper-lower ratio value.

According to the vehicle control device 1 according to the present embodiment, the following effects are exerted.
(1) In the vehicle control device 1, the input image acquirer 2 acquires, as the input image, an image captured by the onboard camera C directed to the front side viewing from the vehicle V, the target steering amount calculator 3 calculates the target steering amount for the electric power steering device 9 of the vehicle V based on the input image, and the steering controller 4 manipulates the electric power steering device 9 to the positive side or the negative side based on the target steering amount. In addition, the target steering amount calculator 3 in the vehicle control device 1 recognizes the own vehicle travel path based on the input image, and calculates at least either one of the positive-side area value between the neutral reference line and the positive-side dividing line of the own vehicle travel path, and the negative-side area value between the neutral reference line and the negative-side dividing line of the own vehicle travel path in the input image. Herein, there is a tendency for the positive-side area value to become larger proportionally to the distance along the width direction between the neutral dividing line and the positive-side dividing line, and the negative-side area value to become larger proportionally to the distance along the width direction between the neutral dividing line and the negative-side dividing line. In other words, in the case of trying to move the vehicle V along the own vehicle travel path, it is necessary to manipulate the electric power steering device 9 to the positive side or the negative side so that the distance between the neutral dividing line and the positive-side dividing line or negative-side dividing line, i.e. the positive-side area value or the negative-side area value, becomes roughly constant. In addition, in the case of the own vehicle travel path on the front side curving to the positive side when viewing from the vehicle V, i.e. case of requiring to manipulate the electric power steering device 9 gradually to the positive side, since the distance along the width direction between the neutral dividing line and the positive-side dividing line becomes longer as distancing from the vehicle V, the positive-side area value increases. In addition, in the case of the own vehicle travel path on the front side curving to the negative side when viewing from the vehicle V, i.e. case of requiring to manipulate the electric power steering device 9 gradually to the negative side, since the distance along the width direction between the neutral dividing line and the negative-side dividing line becomes longer as distancing from the vehicle V, the negative-side area value increases. In this way, the steering amount in the case of having the vehicle V travel along the own vehicle travel path has a correlation with the positive-side area value or negative-side area value defined in the above way. Therefore, the target steering amount calculator 3 can cause the vehicle V to move along the own vehicle travel path by calculating the target steering amount using such a correlation between the steering amount and the area value in the input image. In this way, according to the vehicle control device 1, since it is possible to calculate the proper target steering amount by simply calculating the area value from the input image, it is possible to reduce the load on the computer handling such computations.

In addition, with the input image captured by the onboard camera C, the area of an object that is far away from the vehicle V appears smaller than the area of an object that is near the vehicle V. Therefore, by configuring in the above way, the positive-side area value and the negative-side area value calculated can be considered to be naturally weighted without going through the setting of parameters. Consequently, by calculating the target steering amount based on such a positive-side area value or negative-side area value, it is possible to reduce the number of parameters required by tuning and the load on the computer, compared to the conventional technology, and thus can contribute to the development of a sustainable transportation system.
(2) The target steering amount calculator 3 calculates the target steering amount so as to become larger to the positive side as the positive-side area value becomes larger, and calculates the target steering amount so as to become larger to the negative side as the negative-side area value becomes larger. It is thereby possible to have the vehicle V move so as not to deviate from the own vehicle travel path.
(3) The target steering amount calculator 3 calculates, as the positive-side area value, a value of the area of the region surrounded by the neutral reference line extending in the up-down direction in the input image, the plurality of horizontal reference lines intersecting this neutral reference line, and the positive-side dividing line, and calculates, as the negative-side area value, a value of the area of the region surrounded by the neutral reference line, the plurality of horizontal reference lines and the negative-side dividing line. Consequently, according to the vehicle control device 1, it is possible to calculate the positive-side area value or negative-side area value with a simple computation.
(4) The target steering amount calculator 3 calculates the target steering amount by subtracting a predetermined negative-side reference value from the positive-side area value, subtracting the negative-side area value from a predetermined positive-side reference value, or subtracting the negative-side area value from the positive-side area value. Consequently, according to the vehicle control device 1, so long as it is possible to recognize at least either one of the positive-side dividing line and negative-side dividing line from the input image, the target steering amount can be calculated.
(5) The target steering amount calculator 3, in the case of the positive-side dividing line and the neutral reference line intersecting in the input image, i.e. case of the positive-side dividing line greatly curving to the negative side ahead of the vehicle V, calculates the positive-side area value by subtracting the value of the area between a portion of the neutral reference line on an upper side from the intersection point (i.e. far side viewing from the vehicle V) and the positive-side dividing line, from the value of the area between a portion of the neutral reference line on a lower side from the intersection point with the positive-side dividing line (near side viewing from the vehicle V) and the positive-side dividing line. It is thereby possible to calculate the positive-side area value taking consideration of the curvature of the own vehicle travel path.
(6) The target steering amount calculator 3, in the case of the negative-side dividing line and the neutral reference line intersecting in the input image, i.e. case of the negative-side dividing line curving greatly to the positive side ahead of the vehicle V, calculates the negative-side area value by subtracting the value of the area between a portion of the neutral reference line on an upper side from the intersection point (i.e. far side viewing from the vehicle V) and the negative-side dividing line, from the value of the area between a portion of the neutral reference line on a lower side from the intersection point with the negative-side dividing line (i.e. near side viewing from the vehicle V) and the negative-side dividing line. It is thereby possible to calculate the negative-side area value taking consideration of the curvature of the own vehicle travel path.
(7) The target steering amount calculator 3 calculates the target steering amount by dividing the difference between the positive-side area value and the negative-side reference line by the sum of the positive-side area value and the negative-side reference line, dividing the difference between the positive-side reference line and the negative-side area value by the sum of the positive-side area value and the negative-side area value, or dividing the difference between the positive-side area value and the negative-side area value by the sum of the positive-side area value and the negative-side area value. In other words, the vehicle control device 1 can improve the robustness by calculating the target steering amount by normalizing the positive-side area value and the negative-side area value.
(8) The onboard camera C is provided at the center in the width direction of the vehicle body. In addition, the target steering amount calculator 3, in the case of causing the vehicle V to travel along within the own vehicle travel lane between the positive-side dividing line and the negative-side dividing line, sets the neutral reference line at the center in the width direction of the input image. It is thereby possible to have the vehicle V travel so that the neutral reference line is located at the center between the positive-side dividing line and the negative-side dividing line in the input image, i.e. so that the vehicle body is located at the center of the own vehicle travel lane.
(9) The target steering amount calculator 3 stores, as a center position, the position of the neutral reference line L0 at which the positive-side area value Sp and the negative-side area value Sn are made equal, when the vehicle V is traveling at the center in the width direction of a straight road. In addition, the target steering amount calculator 3 sets the neutral reference line L0 at a center position, in the case of causing the vehicle V to travel along within the own vehicle travel lane. It is thereby possible to cause the vehicle V to travel so that the vehicle body is positioned at the center in the own vehicle travel lane, even in the case of the onboard camera C not being provided at the center in the width direction of the vehicle body.
(10) The target steering amount calculator 3, in the case of causing the vehicle V to travel from the own vehicle travel lane towards a positive-side adjacent travel lane, causes the neutral reference line to move at a predetermined speed to the positive side in the input image. It is thereby possible to cause the vehicle V to automatically move from the own vehicle travel lane to the positive-side adjacent travel lane. In addition, the target steering amount calculator 3, in the case of causing the vehicle V to travel from the own vehicle travel lane towards the negative-side adjacent travel lane, causes the neutral reference line to move at a predetermined speed to the negative side in the input image. It is thereby possible to cause the vehicle V to automatically move from the own vehicle travel lane to the negative-side adjacent travel lane.
(11) The target steering amount calculator 3, in the case of recognizing the positive-side dividing line and a positive-side obstacle hiding a part thereof based on the input image, causes the neutral reference line to move to the negative side in the input image. It is thereby possible to make the vehicle V avoid the positive-side obstacle. In addition, the target steering amount calculator 3, in the case of recognizing the negative-side dividing line and a negative-side obstacle hiding a part thereof based on the input image, causes the neutral reference line to move to the positive side in the input image. It is thereby possible to make the vehicle V avoid the negative-side obstacle.
(12) The target steering amount calculator 3, in the case of being able to recognize the positive-side dividing line and not being able to recognize the negative-side dividing line based on the input image, estimates the negative-side dividing line based on the positive-side dividing line. In addition, the target steering amount calculator 3, in the case of being able to recognize the negative-side dividing line and not being able to recognize the positive-side dividing line based on the input image, estimates the positive-side dividing line based on the negative-side dividing line. Consequently, according to the vehicle control device 1, even in the case of not being able to recognize any of the positive-side dividing line and negative-side dividing line, calculates both the positive-side area value and the negative-side area value, and consequently can calculate the target steering amount using both this positive-side area value and negative-side area value.
(13) The target steering amount calculator 3, in the case of recognizing the positive-side dividing line and a positive-side obstacle hiding a part thereof based on the input image, interpolates a portion of the positive-side dividing line hidden by the positive-side obstacle, by a line along a lateral face on the negative side of the positive-side obstacle. Since it is thereby possible to make the positive-side area value smaller by the amount occupied by the positive-side obstacle, the vehicle V can be made to avoid the positive-side obstacle. In addition, the target steering amount calculation means, in the case of recognizing the negative-side dividing line and the negative-side obstacle hiding a part thereof based on the input image, interpolates a portion of the negative-side dividing line hidden by the negative-side obstacle by a line along a lateral face on the positive side of the negative-side obstacle. Since it is thereby possible to make the negative-side area value smaller by the amount occupied by the negative-side obstacle, the vehicle V can be made to avoid the negative-side obstacle.
(14) The target vehicle speed calculator 5 calculates the target vehicle speed based on the input image, and the acceleration-deceleration controller 6 manipulates the power plant 8 and braking device 7 based on the target vehicle speed. In addition, the target vehicle speed calculator 5 recognizes the own vehicle travel path based on the input image, sets the speed control reference line extending in the width direction of the input image, calculates the value of the area of the own vehicle travel path on the upper side from the speed control reference line as an upper area value, calculates the value of the area of the own vehicle travel path on a lower side from the speed control reference line as a lower area value, calculates a sum of these area values as a total area value, calculates a value of a ratio of the upper area value relative to the total area value as an upper-lower ratio value, and further calculates a target vehicle speed based on the upper-lower ratio value. Herein, in the case of the own vehicle travel path on the front side of the vehicle V curving to the positive side or the negative side, i.e. case requiring to decelerate the vehicle speed, the upper-lower ratio value becomes larger than a case of the travel path being straight ahead. Consequently, according to the vehicle control device 1, it is possible to control the vehicle speed with a simply computation using the correlation between the appropriate vehicle speed according to the status of the travel path ahead, and the upper-lower ratio value defined as described above.
(15) The target vehicle speed calculator 5 calculates the target vehicle speed so as to become smaller as the upper-lower ratio value becomes larger. It is thereby possible to change the vehicle speed according to the status of the own vehicle travel path on the front side of the vehicle V.
(16) The target vehicle speed calculator 5 estimates a curvature parameter of the own vehicle travel path based on the input image, further selects one from among the plurality of speed tables based on this curvature parameter, and calculates the target vehicle speed based on the selected speed table and the upper-lower ratio value. Consequently, according to the vehicle control device 1, it is possible to change the vehicle speed according to the curvature parameter of the own vehicle travel path.
(17) The target vehicle speed calculator 5 acquires the travel mode of the vehicle V, further selects one from among a plurality of speed tables based on this travel mode, and calculates the target vehicle speed based on the selected speed table and the upper-lower ratio value. Consequently, according to the vehicle control device 1, it is possible to change the vehicle speed according to the curvature parameter of the own vehicle travel path.
(18) The target vehicle speed calculator 5, in the case of being able to recognize the positive-side dividing line and not being able to recognize the negative-side dividing line based on the input image, estimates the negative-side dividing line based on the positive-side dividing line. In addition, the target vehicle speed calculator 5, in the case of being able to recognize the negative-side dividing line and not being able to recognize the positive-side dividing line based on the input image, estimates the positive-side dividing line based on the negative-side dividing line. Consequently, according to the vehicle control device 1, even in the case of not being able to recognize any of the positive-side dividing line and the negative-side dividing line, it is possible to calculate the upper area value, lower area value, upper-lower ratio value, etc., and consequently possible to calculate the target vehicle speed using this upper area value, lower area value, upper-lower ratio value, etc.

### Second Embodiment

Next, a vehicle control device according to a second embodiment of the present invention will be described while referencing the drawings. It should be noted that the vehicle control device according to the present embodiment differs in the configuration of the target vehicle speed calculator, from the vehicle control device 1 according to the first embodiment.

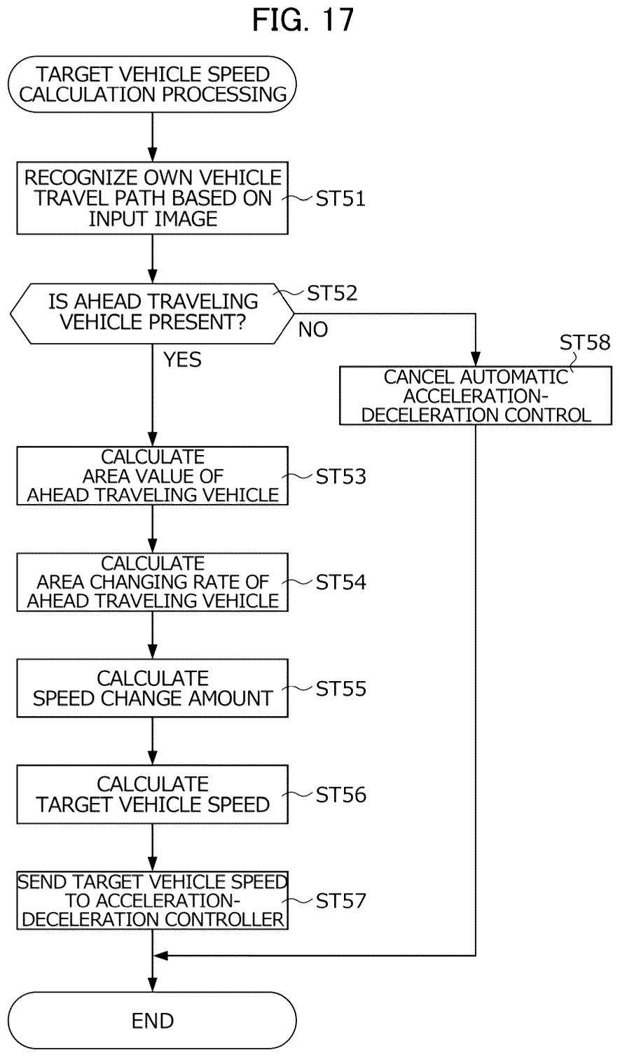

FIG. 17 is a flowchart showing a specific sequence of target vehicle speed calculation processing in the target vehicle speed calculator according to the present embodiment. This target vehicle speed calculation processing is executed by the target vehicle speed calculator every time a new input image is acquired by the input image acquirer 2.

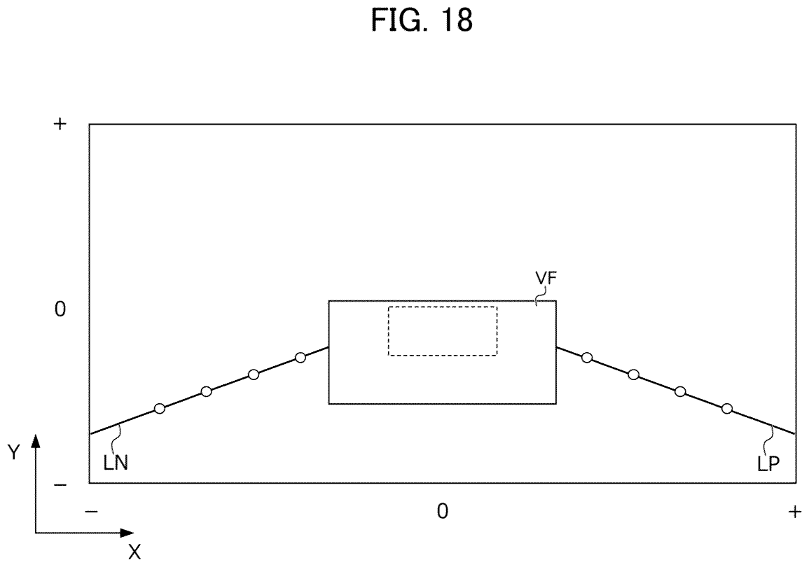

FIG. 18 is a view showing an example of an input image. Hereinafter, a specific sequence of the target vehicle speed calculation processing of FIG. 17 will be described with the input image shown in FIG. 18 as an example.

First, in Step ST51, the target vehicle speed calculator recognizes the own vehicle travel path based on the input image, and then advances to Step ST52. It should be noted that the sequence of recognizing the own vehicle travel path, the positive-side dividing line LP, negative-side dividing line LN, etc. corresponding to the boundaries thereof from the input image in the target vehicle speed calculator is the same as the sequence of processing (for example, Step ST1) in the target steering amount calculator 3; therefore, a detailed description thereof will be omitted.

In Step ST52, the target vehicle speed calculator determines whether an ahead traveling vehicle VF set as a tracking target of the vehicle V exists on the own vehicle travel path recognized in Step ST51. The target vehicle speed calculator advances to Step ST53 in the case of the determination result in Step ST52 being YES, and advances to Step ST58 in the case of the determination result in Step ST52 being NO. In addition, in Step ST58, the target vehicle speed calculator cancels the automatic acceleration-deceleration control by the acceleration-deceleration controller 6, and then ends the target vehicle speed calculation processing of FIG. 17.

Next, in Step ST53, the target vehicle speed calculator calculates an area value of the ahead traveling vehicle VF in the acquired input image in the current control cycle. It should be noted that FIG. 18 shows the ahead traveling vehicle VF in the input image acquired in the previous control cycle by a dashed line.

Next, in Step ST54, the target vehicle speed calculator calculates an area changing rate dS(t) of the ahead traveling vehicle VF based on the following Equation (10), and then advances to Step ST55. It should be noted that, in the following Equation (10), “S(t)” indicates the area value (area value of solid line portion in FIG. 18) of the ahead traveling vehicle VF calculated in the current control cycle, and “S(t−1)” indicates the area value (i.e. area value of dashed line portion in FIG. 18) of the ahead traveling vehicle VF in the previous control cycle, and “At” indicates the control cycle.

$$dS ( t ) = ( S ( t ) - S ( t - 1 ) ) / Δ t \qquad ( 10 )$$

Next, in Step ST55, the target vehicle speed calculator calculates the speed change amount dv(t) based on the area value S(t) of the ahead traveling vehicle VF calculated in Step ST53 and the area changing rate dS(t), and then advances to Step ST56. More specifically, the target vehicle speed calculator reads a speed change amount table determined in advance from a storage medium (not shown), and calculates the speed change amount dv(t), by searching the read speed change amount table based on the area value S(t) and area changing rate dS(t) of the ahead traveling vehicle VF. It should be noted that this speed change amount table is set so that the area value S(t) of the ahead traveling vehicle VF in the input image is maintained roughly constant, in the case of calculating the target vehicle speed in accordance with Equation (11) described later.

Next, in Step ST56, the target vehicle speed calculator calculates the target vehicle speed v(t) by adding the speed change amount dv(t) calculated in Step ST55 to the target vehicle speed v(t−1) of a previous control cycle, as shown in the following Equation (11), and then advances to Step ST57. Herein, the target vehicle speed calculator sets the target vehicle speed v(t) to 0, in the case of the target vehicle speed v(t) calculated in accordance with the following Equation (11) being a negative value. In addition, in the case of the target vehicle speed v(t) calculated in accordance with the following Equation (11) being greater than a predetermined vehicle speed upper limit vlim, the target vehicle speed calculator sets the target vehicle speed v(t) to the vehicle speed upper limit vlim.

$$v ( t ) = v ( t - 1 ) + dv ( t ) \qquad ( 11 )$$

Next, in Step ST57, the target vehicle speed calculator sends the calculated target vehicle speed to the acceleration-deceleration controller 6, and then ends the target vehicle speed calculation processing shown in FIG. 17.

According to the above such target vehicle speed calculation processing according to present embodiment, it is possible to calculate the target vehicle speed so that the area value of the ahead traveling vehicle VF in the input image is maintained roughly constant. Herein, the area value of the ahead traveling vehicle VF in the input image is proportional to the inter-vehicle distance between the vehicle V and the ahead traveling vehicle VF. Therefore, according to the present embodiment, it is possible to make the vehicle V track the ahead traveling vehicle VF by a simple computation using the input image.

### Third Embodiment

Next, a flying vehicle control device according to a third embodiment of the present invention will be described while referencing the drawings.

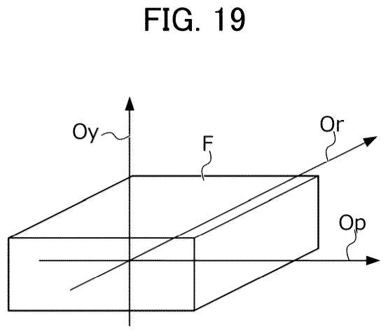

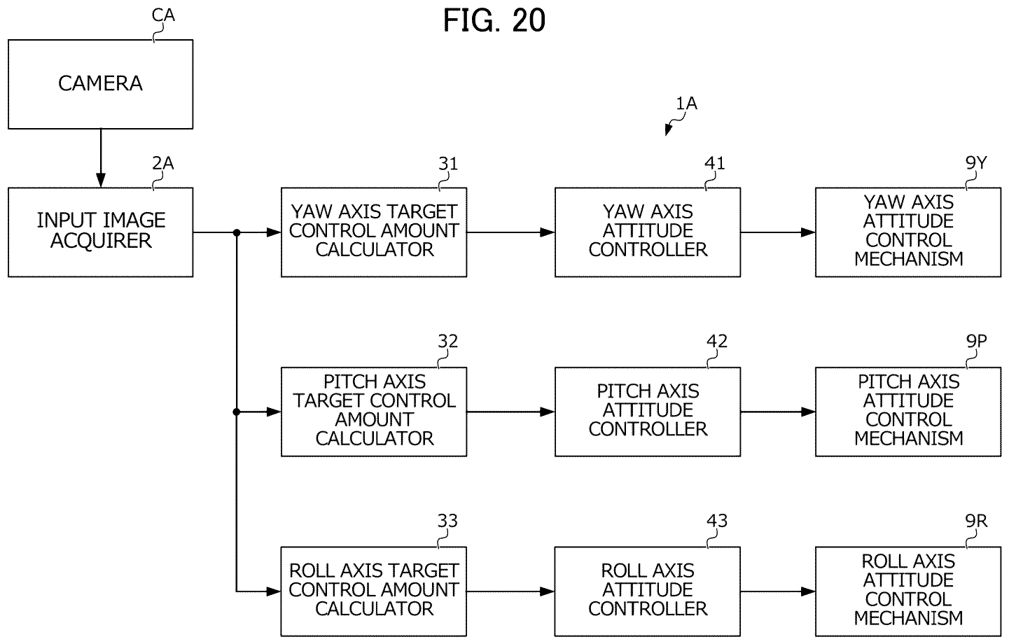

FIG. 19 is a view schematically showing the configuration of a flying vehicle F equipped with a flying vehicle control device 1A according to the present embodiment. FIG. 20 is a functional block diagram of the flying vehicle control device 1A.

The flying vehicle F, for example, is a drone, an aircraft, a helicopter, a VTOL aircraft or the like. The flying vehicle F includes: a propulsion mechanism (not shown) which propels the airframe thereof along the propulsion direction parallel to the roll axis Or; a camera CA provided to the airframe in a state directed to the front side along this propulsion direction; a yaw axis attitude control mechanism 9Y that varies the attitude around the yaw axis Oy of the airframe during flight; a pitch axis attitude control mechanism 9P that varies the attitude around the pitch axis Op of the airframe during flight; a roll axis attitude control mechanism 9R that varies the attitude around the roll axis Or of the airframe during flight; and the flying vehicle control device 1A that controls this yaw axis attitude control mechanism 9Y, pitch axis attitude control mechanism 9P, and roll axis attitude control mechanism 9R based on the images captured by the camera CA.

As shown in FIG. 19, the roll axis Or extends in parallel to a propulsion direction of the airframe, and the yaw axis Oy and pitch axis Op extend in a plane orthogonal to the roll axis Or. In addition, the yaw axis Oy extends in parallel to an up-down direction of the airframe, and the pitch axis Op extends in parallel to a width direction of the airframe orthogonal to the yaw axis Oy.

The yaw axis attitude control mechanism 9Y varies the attitude around the yaw axis Oy of the airframe during flight according to a control signal sent from the flying vehicle control device 1A. More specifically, the yaw axis attitude control mechanism 9Y causes the airframe during flight to rotate to a positive side (for example, clockwise when viewing the airframe from above) or negative side (for example, counter-clockwise when viewing the airframe from above) about the yaw axis Oy.

The pitch axis attitude control mechanism 9P varies the attitude around the pitch axis Op of the airframe during flight according to a control signal sent from the flying vehicle control device 1A. More specifically, the pitch axis attitude control mechanism 9P causes the airframe during flight to rotate to the positive side (for example, clockwise when viewing the airframe from the right) or negative side (for example, counter-clockwise when viewing the airframe from the right) about the pitch axis Op.

The roll axis attitude control mechanism 9R varies the attitude around the roll axis Or of the airframe during flight according to a control signal sent from the flying vehicle control device 1A. More specifically, the roll axis attitude control mechanism 9R causes the airframe during flight to rotate to the positive side (for example, clockwise when viewing the airframe from behind) or negative side (for example, counter-clockwise when viewing the airframe from behind) about the roll axis Or.

The camera CA is directed to the front side along the propulsion direction viewing from the flying vehicle F. In addition, the present embodiment describes a case of the camera CA being provided at the center in the width direction of the airframe of the flying vehicle F; however, the present invention is not limited thereto.

The flying vehicle control device 1A controls the yaw axis attitude control mechanism 9Y, the pitch axis attitude control mechanism 9P and the roll axis attitude control mechanism 9R based on an image of the front side of the flying vehicle F captured by the camera CA. The flying vehicle control device 1A is a computer configured by hardware such as an arithmetic processing means such as a CPU, an auxiliary storage means such as HDD or SSD which stores programs to cause yaw axis target control amount calculation processing, pitch axis target control amount calculation processing, and roll axis target control amount calculation processing described later to be executed in the arithmetic processing means; and a main storage means such as RAM for storing data which is temporarily necessitated upon the arithmetic processing means executing programs.

As shown in FIG. 20, the flying vehicle control device 1A configures an input image acquirer 2A, a yaw axis target control amount calculator 31, a pitch axis target control amount calculator 32, a roll axis target control amount calculator 33, a yaw axis attitude controller 41, a pitch axis attitude controller 42 and a roll axis attitude controller 43 by the aforementioned such hardware configuration.

The input image acquirer 2A acquires an image of the front side of the flying vehicle F captured by the camera CA as an input image. The input image acquirer 2A sends the acquired input image to the yaw axis target control amount calculator 31, the pitch axis target control amount calculator 32 and the roll axis target control amount calculator 33.

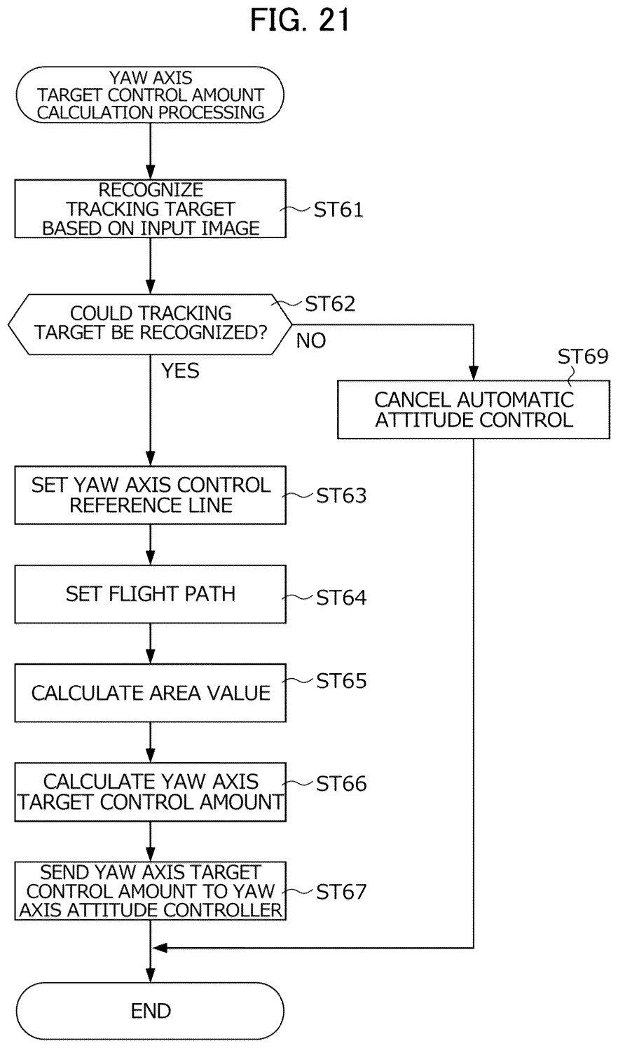

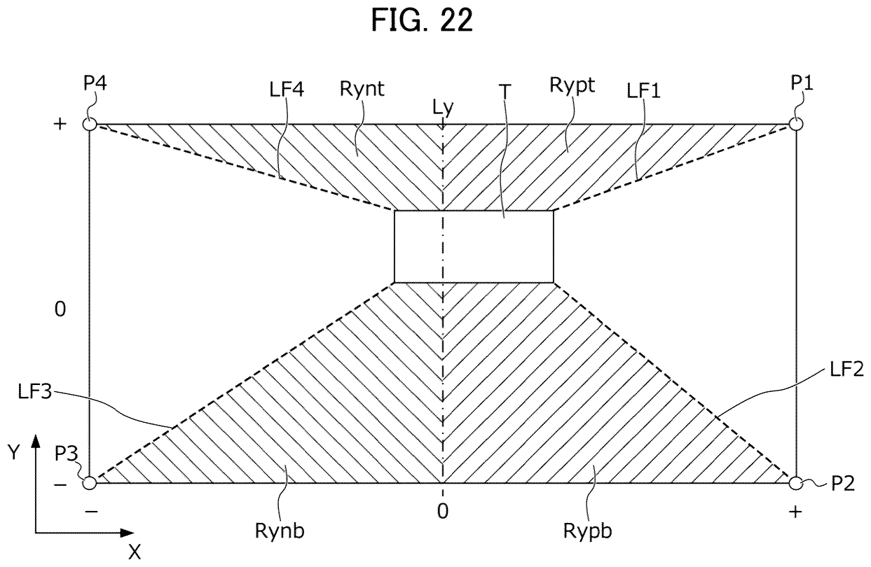

The yaw axis target control amount calculator 31 calculates the yaw axis target control amount relative to the yaw axis control amount of the yaw axis attitude control mechanism 9Y, based on the input image sent from the input image acquirer 2A. It should be noted that a sequence of calculating the yaw axis target control amount based on the input image in the yaw axis target control amount calculator 31 will be described while referencing FIGS. 21, 22, etc. later. The yaw axis attitude controller 41 executes automatic attitude control of manipulating the yaw axis attitude control mechanism 9Y to the positive side or the negative side, based on the yaw axis target control amount calculated by the yaw axis target control amount calculator 31.

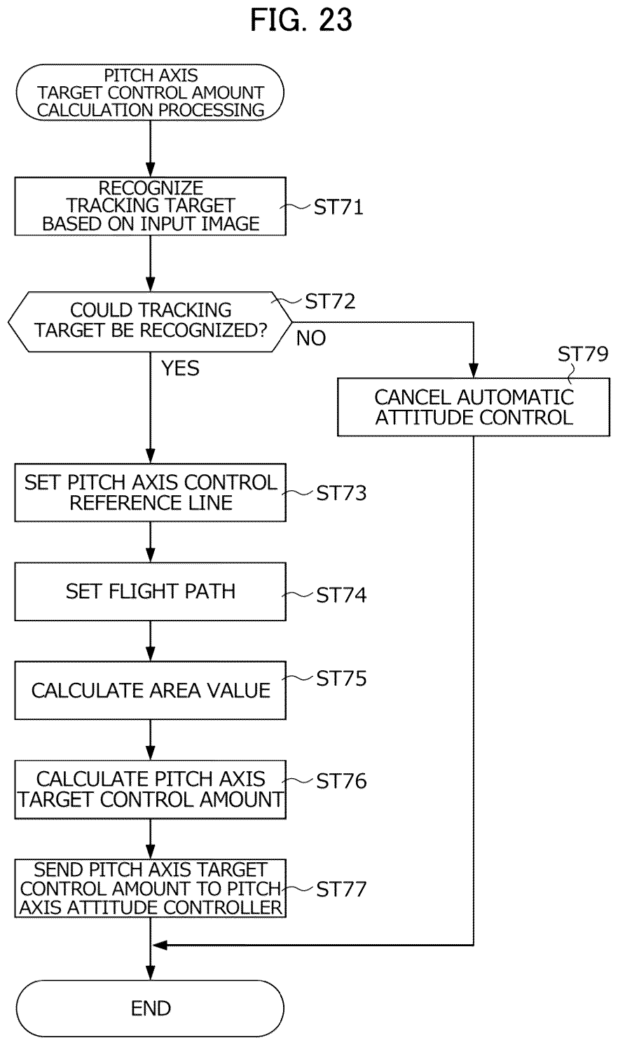

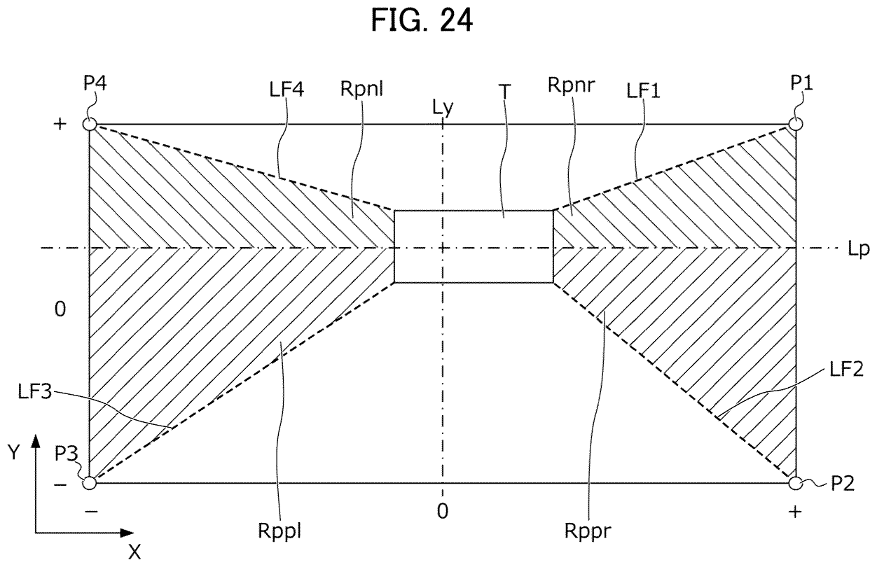

The pitch axis target control amount calculator 32 calculates the pitch axis target control amount relative to the pitch axis control amount of the pitch axis attitude control mechanism 9P, based on the input image sent from the input image acquirer 2A. It should be noted that a sequence of calculating the pitch axis target control amount based on the input image in the pitch axis target control amount calculator 32 will be described while referencing FIGS. 23, 24, etc. later. The pitch axis attitude controller 42 executes automatic attitude control of manipulating the pitch axis attitude control mechanism 9P to the positive side or the negative side based on the pitch axis target control amount calculated by the pitch axis target control amount calculator 32.

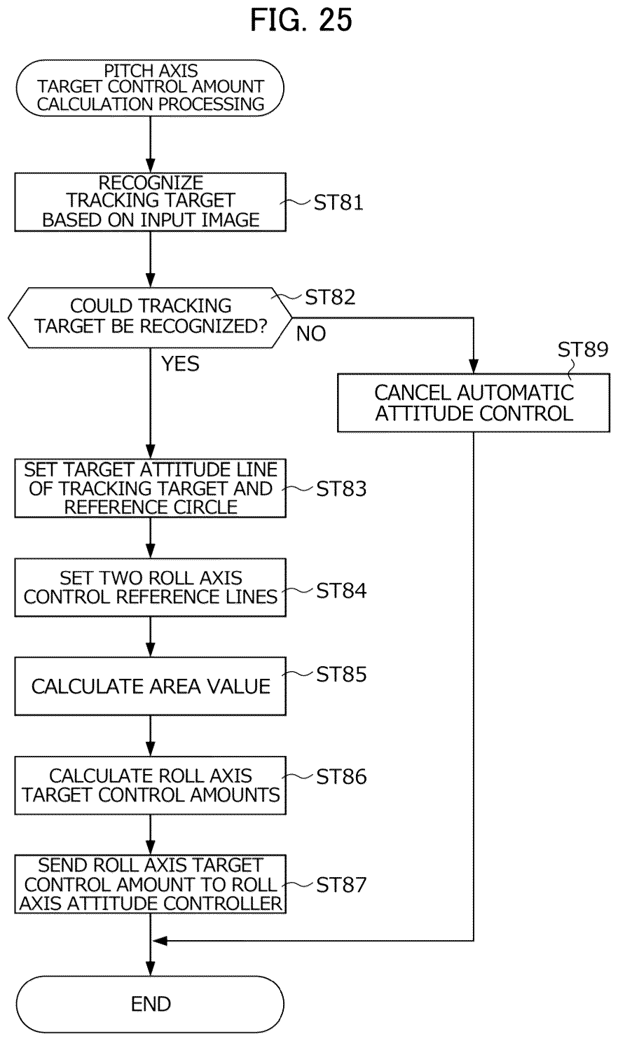

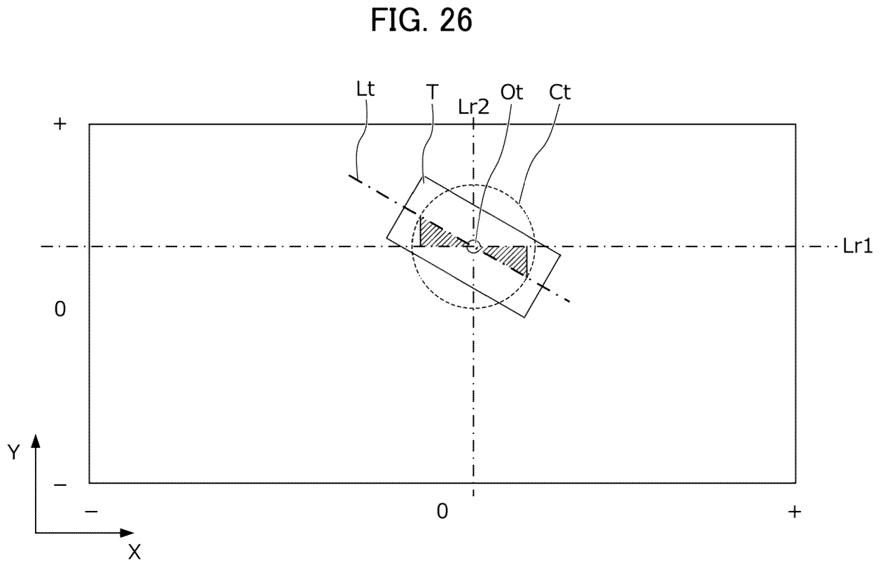

The roll axis target control amount calculator 33 calculates the roll axis target control amount relative to the roll axis control amount of the roll axis attitude control mechanism 9R, based on the input image sent from the input image acquirer 2A. It should be noted that a sequence of calculating the roll axis target control amount based on the input image in the roll axis target control amount calculator 33 will be described while referencing FIGS. 25, 26, etc. later. The roll axis attitude controller 43 executes automatic attitude control of manipulating the roll axis attitude control mechanism 9R to the positive side or the negative side based on the roll axis target control amount calculated by the roll axis target control amount calculator 33.

FIG. 21 is a flowchart showing a specific sequence of yaw axis target control amount calculation processing of calculating the yaw axis target control amount based on the input image. This yaw axis target control amount calculation processing is executed by the yaw axis target control amount calculator 31 every time a new input image is acquired by the input image acquirer 2A.

FIG. 22 is a view showing an example of an input image. Hereinafter, a specific sequence of the yaw axis target control amount calculation processing of FIG. 21 will be described with the input image shown in FIG. 22 as an example.

First, in Step ST61, the yaw axis target control amount calculator 31 recognizes a tracking target T of the flying vehicle F based on the input image, and then advances to Step ST62.

Next, in Step ST62, the yaw axis target control amount calculator 31 determines whether or not a tracking target T could be recognized from the input image in Step ST61. The yaw axis target control amount calculator 31 advances to Step ST63 in the case of the determination result in Step ST62 being YES, and advances to Step ST69 in the case of the determination result in Step ST62 being NO. In addition, in Step ST69, the yaw axis target control amount calculator 31 cancels the automatic attitude control by the yaw axis attitude controller 41, and then ends the yaw axis target control amount calculation processing of FIG. 21.

Next, in Step ST63, the yaw axis target control amount calculator 31 virtually sets a yaw axis control reference line Ly within the input image, and then advances to Step ST64. Herein, the yaw axis target control amount calculator 31 preferably sets the yaw axis control reference line Ly so as to be parallel to the Y axis within the input image, at the origin of the X axis (i.e. center in width direction of input image) in the input image as shown in FIG. 22.

Next, in Step ST64, the yaw axis target control amount calculator 31 sets a virtual flight path in the input image, by virtually setting a plurality of flight dividing lines LF1, LF2, LF3, LF4 extending radially from the tracking target T, based on the position and attitude of the tracking target T in the input image, and then advances to Step ST65.

More specifically, the yaw axis target control amount calculator 31, as shown in FIG. 22, establishes a plurality of lines linking the plurality of reference points P1, P2, P3, P4 determined at the four corners of the input image with the tracking target T, as flight dividing lines LF1, LF2, LF3, LF4 demarcating the flight path of the flying vehicle F. As shown in FIG. 22, the first reference point P1 is set at the very end on the positive side of the X axis and at the very end on the positive side of the Y axis, the second reference point P2 is set at the very end on the positive side of the X axis and the very end on the negative side of the Y axis, for example, the third reference point P3 is set at the very end on the negative side of the X axis and at the very end on the negative side of the Y axis, for example, and the fourth reference point P4 is set at the very end on the positive side of the X axis and the very end on the positive side of the Y axis, for example.

Next, in Step ST65, the yaw axis target control amount calculator 31 calculates an upper positive-side area value Sypt, an upper negative-side area value Synt, a lower positive-side area value Sypb and a lower negative-side area value Synb, as values of areas of the plurality of regions Rypt, Rynt, Rypb, Rynb divided between the yaw axis control reference line Ly and each of the plurality of flight dividing lines LF1 to LF4 in the input image, and then advances to Step ST66.

More specifically, the yaw axis target control amount calculator 31 calculates the value of the area of the region Rypt between the yaw axis control reference line Ly and the first flight dividing line LF1 in the input image as an upper positive-side area value Sypt; calculates the value of the area of the region Rynt between the yaw axis control reference line Ly and the fourth flight dividing line LF4 in the input image as the upper negative-side area value Synt; calculates the value of the area of the region Rypb between the yaw axis control reference line Ly and the second flight dividing line LF2 in the input image as the lower positive-side area value Sypb; and calculates the value of the area of the region Rynb between the yaw axis control reference line Ly and the third flight dividing line LF3 in the input image as the lower negative-side area value Synb. The yaw axis target control amount calculator 31 calculates these area values Sypt, Synt, Sypb, Synb based on quadrature by parts illustrated in Steps ST12 to ST15. In addition, hereinafter, the sum of the upper positive-side area value Sypt and lower positive-side area value Sypb is defined as the positive-side area value Syp (=Sypt+Sypb), and the sum of the upper negative-side area value Synt and lower negative-side area value Synb is defined as a negative-side area value Syn (=Synt+Synb).

Next, in Step ST66, the yaw axis target control amount calculator 31 calculates the yaw axis target control amount uy based on the positive-side area value Syp and negative-side area value Syn calculated by the above such sequence, and then advances to Step ST67. More specifically, the yaw axis target control amount calculator 31 calculates the yaw axis target control amount uy, so as to become larger to the positive side as the positive-side area value Syp becomes larger, and so as to become larger to the negative side as the negative-side area value Syn becomes larger. It is thereby possible to cause the attitude around the yaw axis of the airframe during flight to change greatly to the positive side (i.e. clockwise when viewing the airframe from above) as the positive-side area value Syp becomes larger. In addition, it is possible to cause the attitude around the yaw axis of the airframe during flight to change greatly to the negative side (i.e. counter-clockwise when viewing the airframe from above) as the negative-side area value Syn becomes larger.

More specifically, the yaw axis target control amount calculator 31 calculates the yaw axis target control amount uy by dividing the difference (Syp-Syn) between the positive-side area value Syp and the negative-side area value Syn by the sum (Syp+Syn) of the positive-side area value Syp and the negative-side area value Syn, and further multiplying by a gain Gain_y determined in advance, as shown in the following Equation (12). It should be noted that, hereinafter, a case of setting the gain Gain_y in the following Equation (12) as a positive constant will be described; however, the present invention is not limited thereto. The gain Gain_y may be established as a negative value. In addition, the value of this gain Gain_y may be varied according to some parameters such as the speed of the airframe.

$$uy = Gain\_y \cdot \frac{Syp - Syn}{Syp + Syn} \qquad ( 12 )$$

In Step ST67, the yaw axis target control amount calculator 31 sends the yaw axis target control amount uy calculated by the above sequence to the yaw axis attitude controller 41, and then ends the yaw axis target control amount calculation processing of FIG. 21.

FIG. 23 is a flowchart showing a specific sequence of pitch axis target control amount calculation processing for calculating the pitch axis target control amount based on the input image. This pitch axis target control amount calculation processing is executed by the pitch axis target control amount calculator 32 every time a new input image is acquired by the input image acquirer 2A.

FIG. 24 is a view showing an example of an input image. Hereinafter, a specific sequence of the pitch axis target control amount calculation processing of FIG. 23 will be described with the input image shown in FIG. 24 as an example.

First, in Step ST71, the pitch axis target control amount calculator 32 recognizes the tracking target T of the flying vehicle F based on the input image, and then advances to Step ST72.

Next, in Step ST72, the pitch axis target control amount calculator 32 determines whether or not the tracking target T could be recognized from the input image in Step ST71. The pitch axis target control amount calculator 32 advances to Step ST73 in the case of the determination result in Step ST72 being YES, and advances to Step ST79 in the case of the determination result in Step ST72 being NO. In addition, in Step ST79, the pitch axis target control amount calculator 32 cancels the automatic attitude control by the pitch axis attitude controller 42, and then ends the pitch axis target control amount calculation processing of FIG. 23.

Next, in Step ST73, the pitch axis target control amount calculator 32 virtually establishes a pitch axis control reference line Lp within the input image, and then advances to Step ST74. Herein, the pitch axis target control amount calculator 32 preferably sets the pitch axis control reference line Lp so as to be orthogonal to the yaw axis control reference line Ly in the input image as shown in FIG. 24.

Next, in Step ST74, the pitch axis target control amount calculator 32 sets a virtual flight path relative to the input image, by virtually setting a plurality of flight dividing lines LF1, LF2, LF3, LF4 extending radially from the tracking target T, by the same sequence as Step ST64, and then advances to Step ST75.

Next, in Step ST75, the pitch axis target control amount calculator 32 calculates a right positive-side area value Sppr, a right negative-side area value Spnr, a left positive-side area value Sppl and a left negative-side area value Spnl as values of the areas of a plurality of regions Rppr, Rpnr, Rppl and Rpnl demarcated between the pitch axis control reference line Lp and each of the plurality of flight dividing lines LF1 to LF4 in the input image, and then advances to Step ST76.

More specifically, the pitch axis target control amount calculator 32 calculates the value of the area of the region Rppr between the pitch axis control reference line Lp and the second flight dividing line LF2 in the input image as the right positive-side area value Sppr; calculates the value of the area of the region Rpnr between the pitch axis control reference line Lp and the first flight dividing line LF1 in the input image as the right negative-side area value Spnr; calculates the value of the area of the region Rppl between the pitch axis control reference line Lp and the third flight dividing line LF3 in the input image as the left positive-side area value Sppl; and calculates the value of the area of the region Rpnl between the pitch axis control reference line Lp and the fourth flight dividing line LF4 in the input image as the left negative-side area value Spnl. The pitch axis target control amount calculator 32, for example, calculates these area values Sppr, Spnr, Sppl, Spnl based on quadrature by parts illustrated in Steps ST12 to ST15. In addition, hereinafter, the sum of the right positive-side area value Sppr and the left positive-side area value Sppl is defined as a positive-side area value Spp (=Sppr+Sppl), and the sum of the right negative-side area value Spnr and the left negative-side area value Spnl is defined as negative-side area value Spn (=Spnr+Spnl)

Next, in Step ST76, the pitch axis target control amount calculator 32 calculates the pitch axis target control amount up based on the positive-side area value Spp and negative-side area value Spn calculated by the above such sequence, and then advances to Step ST77. More specifically, the pitch axis target control amount calculator 32 calculates the pitch axis target control amount up so as to become larger to the positive side as the positive-side area value Spp becomes larger, and so as to become larger to the negative side as the negative-side area value Spn becomes larger. It is thereby possible to cause the attitude around the pitch axis of the airframe during flight to greatly change to the positive side (i.e. clockwise when viewing the airframe from the right) as the positive-side area value Spp becomes larger. In addition, it is possible to cause the attitude around the pitch axis of the airframe during flight to greatly change to the negative side (i.e. counter-clockwise when viewing the airframe from the right) as the negative-side area value Spn becomes larger.

More specifically, the pitch axis target control amount calculator 32 calculates the pitch axis target control amount up by dividing the difference (Spp-Spn) between the positive-side area value Spp and the negative-side area value Spn by the sum (Spp+Spn) of the positive-side area value Spp and the negative-side area value Spn, and further multiplying by a gain Gain_p determined in advance, as shown in the following Equation (13). It should be noted that, hereinafter, a case of establishing the gain Gain_p in the following Equation (13) as a positive constant will be described; however, the present invention is not limited thereto. The gain Gain_p may be established as a negative value. In addition, the value of this gain Gain_p may be varied according to some parameters such as the speed of the airframe.

$$up = Gain\_p \cdot \frac{Spp - Spn}{Spp + Spn} \qquad ( 13 )$$

In Step ST77, the pitch axis target control amount calculator 32 sends the pitch axis target control amount up calculated by the above sequence to the pitch axis attitude controller 42, and then ends the pitch axis target control amount calculation processing of FIG. 23.

FIG. 25 is a flowchart showing a specific sequence of the roll axis target control amount calculation processing for calculating the roll axis target control amount based on the input image. This roll axis target control amount calculation processing is executed by the roll axis target control amount calculator 33 every time a new input image is acquired by the input image acquirer 2A.

FIG. 26 is a view showing an example of an input image. Hereinafter, a specific sequence of the roll axis target control amount calculation processing of FIG. 25 will be described with the input image shown in FIG. 26 as an example.

First, in Step ST81, the roll axis target control amount calculator 33 recognizes a tracking target T of the flying vehicle F based on the input image, and then advances to Step ST82.

Next, in Step ST82, the roll axis target control amount calculator 33 determines whether or not the tracking target T could be recognized from the input image in Step ST81. The roll axis target control amount calculator 33 advances to Step ST83 in the case of the determination result in Step ST82 being YES, and advances to Step ST89 in the case of the determination result in Step ST82 being NO. In addition, in Step ST89, the roll axis target control amount calculator 33 cancels the automatic attitude control by the roll axis attitude controller 43, and then ends the roll axis target control amount calculation processing of FIG. 25.

Next, in Step ST83, the roll axis target control amount calculator 33 virtually sets a target attitude line Lt passing through a center position Ot of the tracking target T, and a reference circle Ct centered at the center position Ot in the input image, based on the position and attitude of the tracking target T within the input image, and then advances to Step ST84. The roll axis target control amount calculator 33 establishes a line that is parallel to the horizontal direction of the airframe of the tracking target T and passing through the center position Ot as a target attitude line Lt, as shown in FIG. 26.

Next, in Step ST84, the roll axis target control amount calculator 33 virtually sets the two of the roll axis control reference lines Lr1, Lr2 within the input image, and then advances to Step ST85. Herein, the roll axis target control amount calculator 33 sets a line passing through the center position Ot of the tracking target T and parallel to the X axis as the first roll axis control reference line Lr1, and sets a line passing through the center position Ot of the tracking target T and orthogonal to the first roll axis control reference line Lr1 as the second roll axis control reference line Lr2. In addition, hereinafter, the input image is dividing into a first quadrant, second quadrant, third quadrant and fourth quadrant, by these two roll axis control reference lines Lr1 and Lr2. Hereinafter, the region above the first roll axis control reference line Lr1 and to the right of the second roll axis control reference line Lr2 is defined as the first quadrant, the region below the first roll axis control reference line Lr1 and to the right of the second roll axis control reference line Lr2 is defined as the second quadrant, the region below the first roll axis control reference line Lr1 and to the left of the second roll axis control reference line Lr2 is defined as the third quadrant, and a region above the first roll axis control reference line Lr1 and to the left of the second roll axis control reference line Lr2 is defined as the fourth quadrant.

Next, in Step ST85, the roll axis target control amount calculator 33 calculates a first area value Sr1, second area value Sr2, third area value Sr3 and fourth area value Sr4 as the values of areas of a plurality of regions divided between the first roll axis control reference line Lr1 and the target attitude line Lt in each quadrant of the input image, and then advances to Step ST86.

More specifically, the roll axis target control amount calculator 33 calculates the value of the area of the region between the first roll axis control reference line Lr1 and the target attitude line Lt in the first quadrant of the input image as the first area value Sr1; calculates the value of the area of the region between the first roll axis control reference line Lr1 and the target attitude line Lt in the second quadrant of the input image as the second area value Sr2; calculates the value of the area of the region between the first roll axis control reference line Lr1 and the target attitude line Lt in the third quadrant of the input image as the third area value Sr3; and calculates the value of the area of the region between the first roll axis control reference line Lr1 and the target attitude line Lt in the fourth quadrant of the input image as the fourth area value Sr4.

Herein, region between the first roll axis control reference line Lr1 and the target attitude line Lt refers to triangular portion (portions indicated by hatching in FIG. 26) demarcated by this first roll axis control reference line Lr1, the target attitude line Lt and an additional line, when establishing the additional line parallel to the second roll axis control reference line Lr2 from the two intersection points with the target attitude line Lt and the reference circle Ct, as shown in FIG. 26, for example. The value of the area in a quadrant in which the target attitude line Lt does not exist is set to 0. In other words, in the example shown in FIG. 26, the target attitude line Lt only exists in the second quadrant and the fourth quadrant, and does not exist in the first quadrant or the third quadrant. Therefore, in the example shown in FIG. 26, the first area value Sr1 and the third area value Sr3 are both 0, and the second area value Sr2 and the fourth area value Sr4 each become the value of an area of a portion indicated by hatching in FIG. 26. In addition, hereinafter, the sum of the second area value Sr2 and the fourth area value Sr4 is defined as the positive-side area value Srp (=Sr2+Sr4), and the sum of the first area value Sr1 and the third area value Sr3 is defined as the negative-side area value Srn (=Sr1+Sr3).

Next, in Step ST86, the roll axis target control amount calculator 33 calculates the roll axis target control amount ur based on the positive-side area value Srp and the negative-side area value Srn calculated by the above such sequence, and then advances to Step ST87. More specifically, the roll axis target control amount calculator 33 calculates the roll axis target control amount ur, so as to become larger to the positive side as the positive-side area value Srp becomes larger, and so as to become larger to the negative side as the negative-side area value Srn becomes larger. It is thereby possible to cause the attitude around the roll axis of the airframe during flight to greatly change to the positive side (i.e. clockwise when viewing the airframe from behind) as the positive-side area value Srp becomes larger. In addition, it is possible to cause the attitude around the roll axis of the airframe during flight to greatly change to the negative side (i.e. counter-clockwise when viewing the airframe from behind) as the negative-side area value Srn becomes larger.

More specifically, the roll axis target control amount calculator 33 calculates the roll axis target control amount ur, by dividing the difference (Srp−Srn) between the positive-side area value Srp and the negative-side area value Srn by the sum (Srp+Srn) of the positive-side area value Srp and the negative-side area value Srn, and further multiplying by a gain Gain_r determined in advance, as shown in the following Equation (14). It should be noted that, hereinafter, a case of establishing the gain Gain_r in the following Equation (14) as a positive constant will be described; however, the present invention is not limited thereto. The gain Gain_r may be established as a negative value. In addition, the value of this gain Gain_r may be varied according to some parameters such as the speed of the airframe.

$$ur = Gain\_r \cdot \frac{Srp - Srn}{Srp + Srn} \qquad ( 14 )$$

In Step ST87, the roll axis target control amount calculator 33 sends the roll axis target control amount ur calculated by the above sequence to the roll axis attitude controller 43, and then ends the roll axis target control amount calculation processing of FIG. 25.

According to the flying vehicle control device 1A related to the present embodiment, the following effects are exerted.
(19) The input image acquirer 2A acquires an image captured by the camera CA directed to the front side viewing from the flying vehicle F as an input image, the yaw axis target control amount calculator 31 calculates the yaw axis target control amount for the yaw axis attitude control mechanism 9Y of the flying vehicle F based on the input image, and the yaw axis attitude controller 41 manipulates the yaw axis attitude control mechanism 9Y to the positive side or the negative side based on the yaw axis target control amount. In addition, the yaw axis target control amount calculator 31 recognizes the tracking target T of the flying vehicle F based on the input image, virtually sets a flight path on the input image based on the position of the tracking target T in the input image, and calculates the yaw axis target control amount uy based on the positive side area value Syp between the yaw axis control reference line Ly and the flight dividing lines LF1 and LF2, which are the positive-side boundaries of the flight path, and the negative-side area value Syn between the yaw axis control reference line Ly and the flight dividing lines LF3 and LF4, which are the negative-side boundaries of the flight path. Consequently, according to the flying vehicle control device 1A, since it is possible to calculate the yaw axis target control amount uy for the yaw axis attitude control mechanism 9Y of the flying vehicle F by simply calculating the area value from the input image, it is possible to reduce the load on a computer handling such a computation.
(20) The pitch axis target control amount calculator 32 calculates the pitch axis target control amount for the pitch axis attitude control mechanism 9P of the flying vehicle F based on the input image, and the pitch axis attitude controller 42 manipulates the pitch axis attitude control mechanism 9P to the positive side or the negative side based on the pitch axis target control amount. In addition, the pitch axis target control amount calculator 32 calculates the pitch axis target control amount up, based on the positive-side area value Spp between the pitch axis control reference line Lp and the flight dividing lines LF2 and LF3, which are the positive-side boundaries of the flight path, and the negative-side area value Spn between the pitch axis control reference line Lp and the flight dividing lines LF1 and LF4 on the negative side of the flight path. Consequently, according to the flying vehicle control device 1A, since it is possible to calculate the pitch axis target control amount up for the pitch axis attitude control mechanism 9P of the flying vehicle F, by simply calculating the area value from the input image, it is possible to reduce the load on the computer handling such a computation.
(21) The roll axis target control amount calculator 33 calculates the roll axis target control amount for the roll axis attitude control mechanism 9R of the flying vehicle F based on the input image, and the roll axis attitude controller 43 manipulates the roll axis attitude control mechanism 9R to the positive side or the negative side based on the roll axis target control amount. In addition, the roll axis target control amount calculator 33 virtually sets the target attitude line Lt on the input image based on the attitude of the tracking target T in the input image, calculates the positive-side area value Srp and the negative-side area value Srn between the first roll axis control reference line Lr1 and the target attitude line Lt determined virtually in the input image, and calculates the roll axis target control amount ur based on these area values Srp, Srn. Consequently, according to the flying vehicle control device 1A, since it is possible to calculate the roll axis target control amount ur for the roll axis attitude control mechanism 9R of the flying vehicle F by simply calculating the area value from the input image, it is possible to reduce the load on the computer handling such a computation.

Although the first to third embodiments of the present invention have been described above, the present invention is not to be limited thereto. The configurations of detailed parts may be modified as appropriate within the scope of the gist of the present invention.

What is claimed is:

1. A vehicle control device comprising:
an input image acquirer that acquires an image captured by a camera directed to a front side viewing from a vehicle, as an input image;
a target steering amount calculator that calculates a target steering amount for a steering mechanism of the vehicle based on the input image; and
a steering controller that manipulates the steering mechanism to a positive side or a negative side based on the target steering amount,
wherein the target steering amount calculator is configured to execute:
processing of recognizing a travel path of the vehicle based on the input image;
processing of calculating at least either one of a positive-side area value between a neutral reference line determined virtually in the input image and a positive-side dividing line which is a boundary on a positive side of the travel path, and a negative-side area value between the neutral reference line and a negative-side dividing line which is a boundary on a negative side of the travel path; and
processing of calculating the target steering amount based on at least either one of the positive-side area value and the negative-side area value.

2. The vehicle control device according to claim 1, wherein the target steering amount calculator calculates the target steering amount so as to become larger to a positive side as the positive-side area value becomes larger, and calculates the target steering amount so as to become larger to a negative side as the negative-side area value becomes larger.

3. The vehicle control device according to claim 2, wherein the target steering amount calculator virtually sets, in the input image, the neutral reference line extending in an up-down direction of the input image, and a plurality of horizontal reference lines that intersect with the neutral reference line, calculates a value of an area of a region surrounded by the positive-side dividing line, the neutral reference line and the horizontal reference lines as the positive-side area value, and calculates a value of an area of a region surrounded by the negative-side dividing line, the neutral reference line and the horizontal reference lines as the negative-side area value.

4. The vehicle control device according to claim 1, wherein the target steering amount calculator calculates the target steering amount by
subtracting a predetermined negative-side reference value from the positive-side area value,
subtracting the negative-side area value from a predetermined positive-side reference value, or
subtracting the negative-side area value from the positive-side area value.

5. The vehicle control device according to claim 4, wherein the target steering amount calculator, in a case of the positive-side dividing line and the neutral reference line intersecting in the input image, calculates the positive-side area value by subtracting a value of an area between a portion of the neutral reference line on an upper side from the intersection point with the positive-side dividing line and the positive-side dividing line, from a value of an area between a portion of the neutral reference line on a lower side from the intersection point and the positive-side dividing line.

6. The vehicle control device according to claim 4, wherein the target steering amount calculator, in a case of the negative-side dividing line and the neutral reference line intersecting in the input image, calculates the negative-side area value by subtracting a value of an area between a portion of the neutral reference line on an upper side from an intersection point with the negative-side dividing line and the negative-side dividing line, from a value of an area between a portion of the neutral reference line on a lower side from the intersection point with the negative-side dividing line and the negative-side dividing line.

7. The vehicle control device according to claim 5, wherein the target steering amount calculator calculates the target steering amount by
dividing a difference between the positive-side area value and the negative-side reference line by a sum of the positive-side area value and the negative-side reference line,
dividing a difference between the positive-side reference line and the negative-side area value by a sum of the positive-side reference line and the negative-side area value, or
dividing a difference between the positive-side area value and the negative-side area value by a sum of the positive-side area value and the negative-side area value.

8. The vehicle control device according to claim 1, wherein the camera is provided at a center in a width direction of a body of the vehicle, and
wherein the target steering amount calculator, in a case of causing the vehicle to travel along within an own vehicle travel lane between the positive-side dividing line and the negative-side dividing line, is configured to execute processing of setting the neutral reference line at a center in a width direction of the input image.

9. The vehicle control device according to claim 1,
wherein the target steering amount calculator is configured to execute:
processing of storing, as a center position, a position of the neutral reference line at which the positive-side area value and the negative-side area value are made equal when the vehicle is traveling at a center in a width direction of a straight road, and
processing of setting the neutral reference line at the center position, in a case of causing the vehicle to travel along within an own vehicle travel lane between the positive-side dividing line and the negative-side dividing line.

10. The vehicle control device according to claim 8,
wherein the target steering amount calculator is configured to execute:
processing to cause the neutral reference line to move at a predetermined speed to a positive side in the input image, in a case of causing the vehicle to travel from the own vehicle travel lane toward a positive-side adjacent travel lane which is adjacent to the positive-side dividing line; and
processing of causing the neutral reference line to move at a predetermined speed to a negative side in the input image, in a case of causing the vehicle to travel from the own vehicle travel lane toward a negative-side adjacent travel lane which is adjacent to the negative-side dividing line.

11. The vehicle control device according to claim 8,
wherein the target steering amount calculator is configured to execute:
processing of causing the neutral reference line to move to a negative side in the input image, in a case of recognizing the positive-side dividing line and a positive-side obstacle hiding a part of the positive-side dividing line, based on the input image; and
processing of causing the neutral reference line to move to a positive side in the input image, in a case of recognizing the negative-side dividing line and a negative-side obstacle hiding a part of the negative-side dividing line, based on the input image.

12. The vehicle control device according to claim 1,
wherein the target steering amount calculator is configured to execute:
processing of estimating the negative-side dividing line based on the positive-side dividing line, in a case of being able to recognize the positive-side dividing line and not being able to recognize the negative-side dividing line based on the input image; and
processing of estimating the positive-side dividing line based on the negative-side dividing line, in a case of being able to recognize the negative-side dividing line and not being able to recognize the positive-side dividing line based on the input image.

13. The vehicle control device according to claim 1,
wherein the target steering amount calculator is configured to execute:
processing of interpolating, in a case of recognizing the positive-side dividing line and a positive-side obstacle hiding a part of the positive-side dividing line based on the input image, a portion of the positive-side dividing line being hidden by the positive-side obstacle by a line along a lateral face on a negative side of the positive-side obstacle; and
processing of interpolating, in a case of recognizing the negative-side dividing line and a negative-side obstacle hiding a part of the negative-side dividing line based on the input image, a portion of the negative-side dividing line being hidden by the negative-side obstacle by a line along a lateral face on a positive side of the negative-side obstacle.

14. The vehicle control device according to claim 1, further comprising:
a target vehicle speed calculator that calculates a target vehicle speed of the vehicle based on the input image; and
an acceleration-deceleration controller that manipulates an acceleration-deceleration device of the vehicle based on the target vehicle speed,
wherein the target vehicle speed calculator is configured to execute:
processing of recognizing the travel path based on the input image;
processing of setting a speed control reference line extending in a width direction relative to the input image;
processing of calculating a value of an area of the travel path on an upper side from the speed control reference line as an upper area value;
processing of calculating a value of an area of the travel path on a lower side from the speed control reference line as a lower area value;
processing of calculating a sum of the upper area value and the lower area value as a total area value;
processing of calculating a value of a ratio of the upper area value relative to the total area value as an upper-lower ratio value; and
processing of calculating the target vehicle speed based on the upper-lower ratio value.

15. The vehicle control device according to claim 14, wherein the target vehicle speed calculator calculates the target vehicle speed so as to become smaller as the upper-lower ratio value becomes larger.

16. The vehicle control device according to claim 14, further comprising:
a storage medium that stores a plurality of speed tables associating the upper-lower ratio value and the target vehicle speed,
wherein the target vehicle speed calculator is configured to execute:
processing of estimating a curvature parameter of the travel path based on the input image; and
processing of selecting one among the plurality of the speed tables based on the curvature parameter, and calculating the target vehicle speed based on the speed table selected and the upper-lower ratio value.

17. The vehicle control device according to claim 14, further comprising:
a storage medium that stores a plurality of speed tables associating the upper-lower ratio value and the target vehicle speed,
wherein the target vehicle speed calculator is configured to execute:
processing of acquiring a travel mode of the vehicle; and
processing of selecting one among a plurality of the speed tables based on the travel mode, and calculating the target vehicle speed based on the speed table selected and the upper-lower ratio value.

18. The vehicle control device according to claim 14,
wherein the target vehicle speed calculator is configured to execute:
processing of estimating the negative-side dividing line based on the positive-side dividing line, in a case of being able to recognize the positive-side dividing line and not being able to recognize the negative-side dividing line based on the input image; and
processing of estimating the positive-side dividing line based on the negative-side dividing line, in a case of being able to recognize the negative-side dividing line and not being able to recognize the positive-side dividing line based on the input image.

19. A vehicle control method for controlling a vehicle by a computer based on an image captured by a camera directed toward a front side viewing from the vehicle, the method comprising the steps of:
acquiring an image captured by the camera as an input image;
recognizing a travel path of the vehicle based on the input image;
calculating at least either one of a positive-side area value between a neutral reference line determined virtually in the input image and a positive-side dividing line which is a boundary on a positive side of the travel path, and a negative-side area value between the neutral reference line and a negative-side dividing line which is a boundary on a negative side of the travel path;
calculating a target steering amount for a steering mechanism of the vehicle based on at least either one of the positive-side area value and the negative-side area value; and
manipulating the steering mechanism to a positive side or a negative side based on the target steering amount.

20. A storage medium for storing a computer program that controls a vehicle by a computer based on an image captured by a camera directed to a front side viewing from the vehicle,
wherein the computer program causes the computer to execute the steps of:
acquiring an image captured by the camera as an input image;
recognizing a travel path of the vehicle based on the input image;
calculating at least either one of a positive-side area value between a neutral reference line determined virtually in the input image and a positive-side dividing line which is a boundary on a positive side of the travel path, and a negative-side area value between the neutral reference line and a negative-side dividing line which is a boundary on a negative side of the travel path;
calculating a target steering amount for a steering mechanism of the vehicle based on at least either one of the positive-side area value and the negative-side area value; and
manipulating the steering mechanism to a positive side or a negative side based on the target steering amount.

21. A flying vehicle control device comprising:
an input image acquirer that acquires an image captured by a camera directed to a front side viewing from the flying vehicle as an input image;
a first target control amount calculator that calculates a first target control amount for a first axis attitude control mechanism that causes an attitude around a first axis of the flying vehicle to change based on the input image; and
a first axis attitude controller that manipulates the first axis attitude control mechanism to a positive side or a negative side based on the first target control amount,
wherein the first target control amount calculator is configured to execute:
processing of recognizing a tracking target of the flying vehicle based on the input image;
processing of setting a flight path virtually on the input image based on a position of the tracking target in the input image;
processing of calculating a first positive-side area value between a first control reference line determined virtually in the input image and a first positive-side dividing line which is a boundary on a positive side of the flight path, and a first negative-side area value between the first control reference line and a first negative-side dividing line which is a boundary on a negative side of the flight path; and
processing of calculating the first target control amount based on the first positive-side area value and the first negative-side area value.

22. The flying vehicle control device according to claim 20, further comprising:
a second target control amount calculator that calculates a second target control amount for a second axis attitude control mechanism that causes an attitude around a second axis of the flying vehicle to change based on the input image; and
a second axis attitude controller that manipulates the second axis attitude control mechanism to a positive side or a negative side based on the second target control amount,
wherein the second target control amount calculator is configured to execute:
processing of calculating a second positive-side area value between a second control reference line determined virtually in the input image so as to be orthogonal to the first control reference line, and a second positive-side dividing line which is a boundary on a positive side of the flight path, and a second negative-side area value between the second control reference line and a second negative-side dividing line which is a boundary on a negative side of the flight path; and
processing of calculating the second target control amount based on the second positive-side area value and the second negative-side area value.

23. The flying vehicle control device according to claim 22, further comprising:
a third target control amount calculator that calculates a third target control amount for a third axis attitude control mechanism that causes an attitude around a third axis of the flying vehicle to change based on the input image; and
a third axis attitude controller that manipulates the third axis attitude control mechanism to a positive side or a negative side based on the third target control amount,
wherein the third target control amount calculator is configured to execute:
processing of setting a target attitude line virtually on the input image based on an attitude of the tracking target in the input image;
processing of calculating a third area value between a third control reference line determined virtually in the input image and the target attitude line; and
processing of calculating the third target control amount based on the third area value.
